(19) United States
(12) Patent Application Publication
(10) Pub. No.: US 2026/0204199 A1
(43) Pub. Date: Jul. 16, 2026

(54) DISPLAY DEVICE AND OPERATION METHOD OF DISPLAY DEVICE

(71) Applicant: Samsung Electronics Co., Ltd., Suwon-si (KR)

(72) Inventors: Yulim SEO, Suwon-si (KR); Huijung LEE, Suwon-si (KR); Younghun JO, Suwon-si (KR); Hyehyun HEO, Suwon-si (KR)

(21) Appl. No.: 19/562,419

(22) Filed: Mar. 10, 2026

Related U.S. Application Data
(63) Continuation of application No. PCT/KR2024/011978, filed on Aug. 12, 2024.

(30) Foreign Application Priority Data
Sep. 14, 2023 (KR) 10-2023-0122671

(51) Int. Cl. G09G 3/20

(52) U.S. Cl. CPC G09G 3/2029; G09G 3/2096; G09G 2320/064; G09G 2360/10

(57) ABSTRACT

A display device may include a display divided into a plurality of blocks and driven, memory, and a processor configured to execute an instruction stored in the memory, to cause the display device to calculate a plurality of duty ratios at which the plurality of blocks are driven within one frame, calculate a first duty margin using a first target duty ratio and a first reference duty ratio, calculate a second duty margin using a second target duty ratio determined by a relational expression between a driving current and a driving duty ratio of the display and a second reference duty ratio, determine a correcting duty margin, and drive the display with a final driving current and a plurality of final duty ratios determined using the plurality of duty ratios and the correcting duty margin.

### CROSS-REFERENCE TO RELATED APPLICATIONS

This application is a continuation of International Application No. PCT/KR2024/011978 designating the United States, filed on August 12, 2024, in the Korean Ministry of Intellectual Property Receiving Office and claiming priority to Korean Patent Application No. 10-2023-0122671, filed on September 14, 2023, in the Korean Ministry of Intellectual Property, the disclosures of each of which are incorporated by reference here in their entireties.

### BACKGROUND

### Field

The disclosure relates to a display device and an operation method of the display device. For example, the disclosure relates to a display device including a display that is divided into a plurality of blocks and is driven, and an operation method of the display device.

### Description of Related Art

With advancements in electronic device technology, operations are being performed to control the luminance of displays that display images.

For example, operations that utilize local dimming technology to control the amount of light by adjusting a duty ratio at which a display is driven in conjunction with an input image are performed. Images can be displayed by dividing a display into a plurality of blocks, operating the respective blocks, and adjusting duty ratios of the respective blocks to different ratios according to input images corresponding to the respective blocks. Also, images can be displayed by controlling the magnitude of a driving current that operates the display based on the respective duty ratios of the plurality of blocks of the display.

In this case, the display may include a backlight for radiating light and perform an operation of controlling a duty ratio of the backlight and a magnitude of a driving current according to an input image.

### SUMMARY

An example embodiment of the present disclosure provides a display device. The display device may include a display divided into a plurality of blocks and configured to be driven. The display device may include memory storing at least one instruction. The display device may include at least one processor, comprising processing circuitry, individually and/or collectively, configured to execute the at least one instruction stored in the memory. At least one processor may be configured to execute the at least one instruction to cause the display device to: obtain an input image; calculate a plurality of duty ratios at which the plurality of blocks are respectively driven within one frame, based on the obtained input image; calculate a first duty margin using a specified first target duty ratio and a first reference duty ratio selected from among the plurality of calculated duty ratios; calculate a second duty margin using a second target duty ratio determined by a specified relational expression between a driving current and a driving duty ratio of the display and a second reference duty ratio determined based on the plurality of calculated duty ratios; determine a correcting duty margin by comparing the first duty margin with the second duty margin; and drive the display with a plurality of final duty ratios determined using the plurality of duty ratios and the correcting duty margin, and a final driving current determined to correspond to the plurality of final duty ratios using the relational expression.

An example embodiment of the present disclosure provides a method of operating a display device. The method of operating the display device may include: obtaining an input image; calculating a plurality of duty ratios at which a plurality of blocks of the display, divided within one frame, are respectively driven, based on the obtained input image; calculating a first duty margin using a specified first target duty ratio and a first reference duty ratio selected from among the plurality of calculated duty ratios; calculating a second duty margin using a second target duty ratio determined by a specified relational expression between a driving duty ratio and a driving current of the display and a second reference duty ratio determined based on the plurality of calculated duty ratios; determining a correcting duty margin by comparing the first duty margin with the second duty margin; and driving the display with a plurality of final duty ratios determined using the plurality of duty ratios and the correcting duty margin and a final driving current determined to correspond to the plurality of final duty ratios using the relational expression.

An example embodiment of the present disclosure provides a non-transitory computer-readable recording medium having recorded thereon a program for performing at least one method among the various embodiments of the method on a computer.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example operation of a display device according to various embodiments.

FIG. 2 is are graphs illustrating a relationship between luminance and a duty ratio of an image and a relationship between luminance and a driving current of an image, according to various embodiments.

FIG. 3 is a block diagram illustrating an example configuration of a display device according to various embodiments.

FIG. 4 is a flowchart illustrating an example operation of a display device according to various embodiments.

FIG. 5 is a flowchart illustrating an example operation of a display device according to various embodiments.

FIG. 6 is a flowchart illustrating an example operation of a display device for calculating a first duty margin, according to various embodiments.

FIG. 7A is a diagram illustrating an example operation of a display device for calculating a first duty margin, according to various embodiments.

FIG. 7B is a diagram illustrating an example operation of a display device for calculating a first duty margin according to a region of interest and a region of non-interest, according to various embodiments.

FIG. 7C is a flowchart illustrating an example operation of a display device for calculating a first duty margin according to motion of an input image, according to various embodiments.

FIG. 8A is a flowchart illustrating an example operation of a display device for calculating a second duty margin, according to various embodiments.

FIG. 8B is a flowchart illustrating an example operation of a display device for calculating a second duty margin according to a mode selection input of selecting a first mode or a second mode, according to various embodiments.

FIG. 9A is a graph illustrating an example operation of a display device for calculating a second duty margin using a first relational expression used in a first mode, and a second target duty ratio determined by the first relational expression according to various embodiments.

FIG. 9B is a graph illustrating an example operation of a display device for calculating a second duty margin using a second relational expression used in a second mode, and a second target duty ratio determined by the second relational expression according to various embodiments.

FIG. 10 is a flowchart illustrating an example operation of a display device for determining a correcting duty margin, according to various embodiments.

FIG. 11 is a graph illustrating a plurality of final duty ratios determined using a correcting duty margin, according to various embodiments.

FIG. 12 is a graph illustrating a final driving current determined using a correcting duty margin, according to various embodiments.

### DETAILED DESCRIPTION

Terms used in the present disclosure will be briefly described, and various example embodiments of the present disclosure will be described in greater detail.

Although general terms being currently widely used were selected as terminology used in the present disclosure while considering the functions of an embodiment of the present disclosure, they may vary according to intentions of one of ordinary skill in the art, judicial precedents, the advent of new technologies, and the like. Terms arbitrarily selected may also be used in a specific case. In this case, their meanings will be described in detail in the disclosure. Hence, the terms used in the present disclosure must be defined based on the meanings of the terms and the entire contents of the present disclosure, not by simply stating the terms themselves.

It is to be understood that the singular forms "a," "an," and "the" include plural referents unless the context clearly dictates otherwise. All terms, including technical terms and scientific terms, used herein have the same meaning as how they are generally understood by those of ordinary skill in the art to which the concept of the present disclosure pertains.

Throughout the present disclosure, it will be understood that when a certain part "includes" a certain component, the part does not exclude another component but can further include another component, unless the context clearly dictates otherwise. Also, in the present disclosure, the terms "part," "portion," or "module" refer to a unit that processes at least one function or operation, and may be implemented as hardware, software, or a combination of hardware and software.

The expression "configured (or set) to" used in the present disclosure can be used interchangeably with, for example, "suitable for," "having the capacity to," "designed to," "adapted to," "made to," or "capable of.", according to situations. The term "configured (or set) to” may not necessarily refer to being "specifically designed to" in hardware. Instead, in some contexts, the expression "a system configured to" may refer, for example, to the system, together with other devices or components, being "capable of" doing something. For example, the phrase "a processor configured (or set) to perform A, B, and C" may refer, for example, to a dedicated processor (e.g., an embedded processor) for performing the corresponding operations, or a generic-purpose processor (e.g., a CPU or application processor) that can perform the corresponding operations by executing one or more software programs stored in memory.

In the present disclosure, it should be understood that when one component is "connected" or "coupled" to another component, the one component may be directly connected or coupled to the other component, but may alternatively be connected or coupled to the other component with an intervening component therebetween, unless specified otherwise.

Hereinafter, various example embodiments of the disclosure will be described in greater detail with reference to the appended drawings. However, the present disclosure can be implemented in various different forms, and is not limited to the example embodiments described herein. In the drawings, parts irrelevant to the description are not shown in order to definitely describe an embodiment of the present disclosure, and throughout the present disclosure, similar components are assigned like reference numerals.

Hereinafter, various example embodiments of the present disclosure will be described in greater detail with reference to the accompanying drawings.

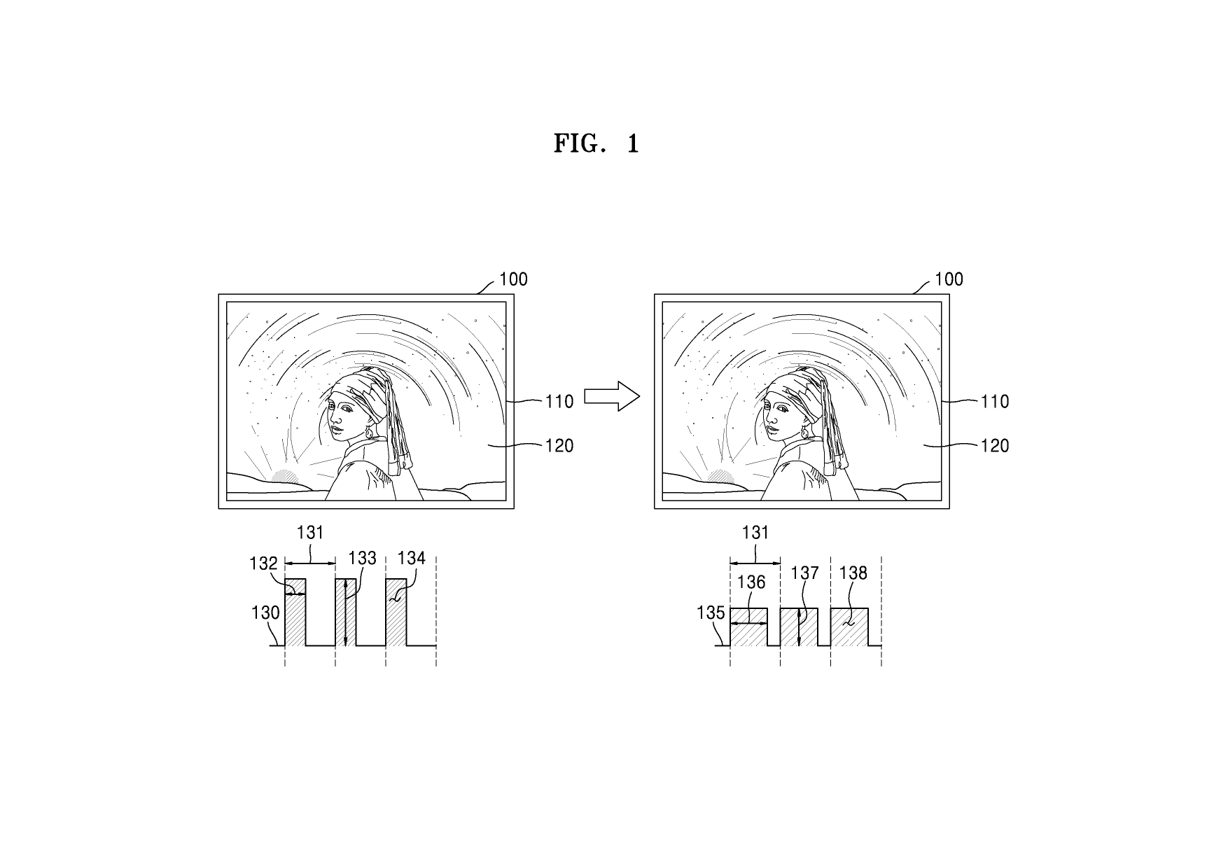

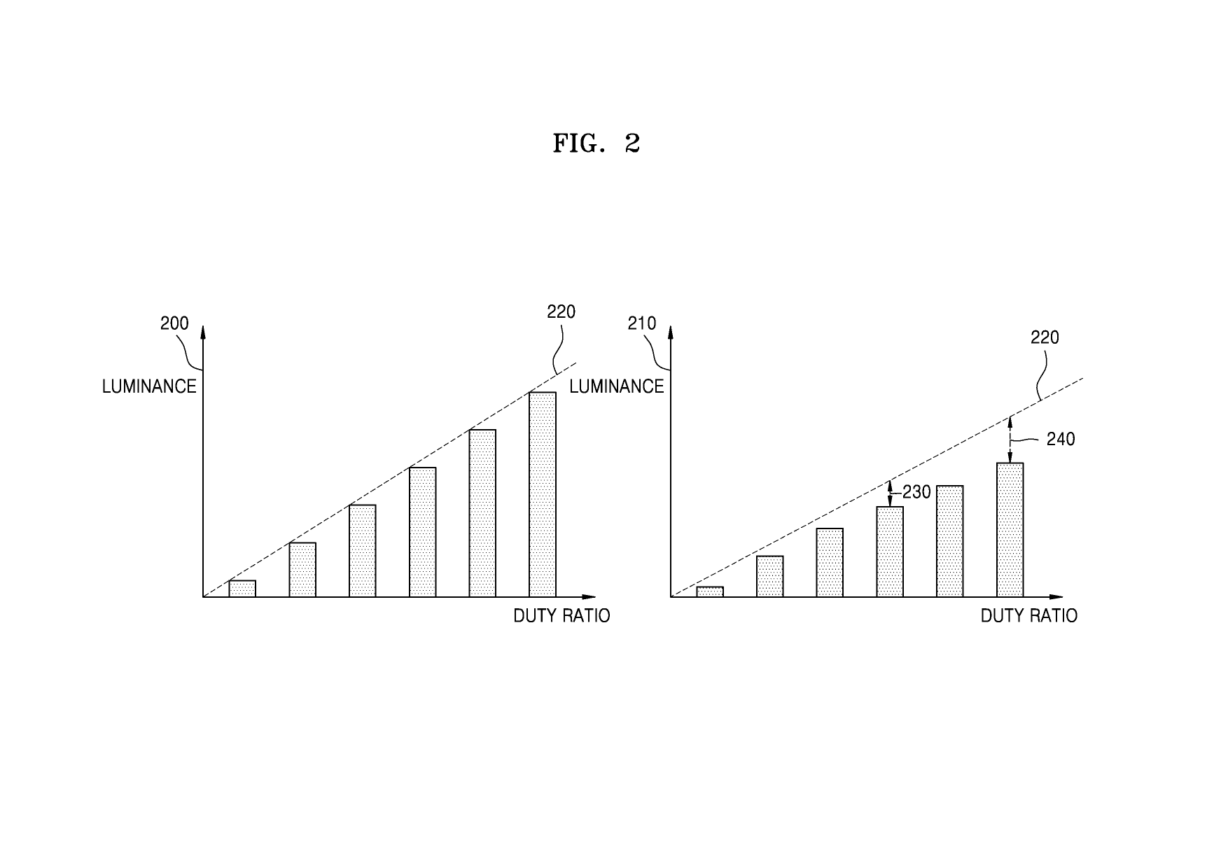

FIG. 1 is a diagram illustrating an example operation of a display device according to various embodiments. FIG. 2 includes graphs illustrating an example operation of a display device according to various embodiments.

Referring to FIG. 1, in an embodiment, a display device 100 may be a device that displays an image 120 to provide the image 120 to a user. In an embodiment, the display device 100 may include a display 110 and display an image 120 on the display 110. The display device 100 may display an image 120 on the display 110 to provide the image 120 to a user.

In an embodiment, referring to FIG. 1, the display device 100 is shown as having a shape of a television, but the present disclosure is not limited thereto. The display device 100 may be implemented as display devices having various shapes, such as a digital signage, a projector, a mobile device, a smart phone, a laptop computer, a desktop, a tablet PC, a wearable device, a head mounted display (HMD) device, etc.

In an embodiment, the display 110 may display an image 120 through a plurality of frames. The display device 100 may control the display 110 to refresh and display an image in each of the plurality of frames.

In an embodiment, a length of each of the plurality of frames may be determined by a driving frequency of the display 110. The display device 100 may control the display 110 to display an image 120 at a driving frequency. In an embodiment, the driving frequency may be a frequency at which the image 120 is refreshed on the display 110. In an embodiment, the driving frequency may be set to various frequencies, such as 1 Hertz (Hz), 30 Hz, 60 Hz, 90 Hz, 120 Hz, 240 Hz, etc., although not limited thereto. In an embodiment, the driving frequency may be set to various values depending on a type of an image displayed on the display 110, a movement of an object within the image, power consumption of the display device 100, etc.

In an embodiment, luminance of an image 120 displayed through the display 110 may be determined by a driving current 130 provided to the display 110. In an embodiment, the display device 100 may control a waveform of the driving current 130 for driving the display 110.

In an embodiment, the display device 100 may control a ratio of a turn-on period 132 and a turn-off period of a driving current within one frame 131. A ratio of a length of the turn-on period 132 to a length of the one frame 131 may be referred to as a duty ratio. In an embodiment, the display device 100 may control a magnitude 133 of a driving current in a turn-on period 132 of the driving current. In an embodiment, the longer the turn-on period 132, the higher luminance of an image 120. In an embodiment, the greater the magnitude 133 of the driving current in the turn-on period 132, the higher the luminance of the image 120.

In an embodiment, an area 134 of the turn-on period 132, which is a product of the length of the turn-on period 132 of the driving current 130 and the magnitude 133 of the driving current in the turn-on period 132, may correspond to power consumption of the display device 100. In an embodiment, the area 134 of the turn-on period may be proportional to the power consumption of the display device 100.

Referring to FIGS. 1 and 2, FIG. 2 illustrates a first graph 200 representing a relationship between luminance of an image and a duty ratio and a second graph 210 representing a relationship between luminance of an image and a driving current. In an embodiment, an x-axis of the first graph 200 may represent a duty ratio and a y-axis of the first graph 200 may represent luminance of an image. An x-axis of the second graph 210 may represent a driving current and a y-axis of the second graph 210 may represent luminance of an image.

In an embodiment, the first graph 200 and the second graph 210 are shown as having slopes 220 representing proportional relationships. In an embodiment, referring to the first graph 200, luminance and a duty ratio of an image may have a proportional relationship corresponding to the slope 220. In an embodiment, as a length of a turn-on period 132 within one frame increases and thus a duty ratio increases, luminance of an image may also increase proportionally.

In an embodiment, referring to the second graph 210, as a magnitude 133 of a driving current increases, luminance of an image also increases. However, compared to the first graph 200, a degree to which the luminance of the image increases as the magnitude 133 of the driving current increases may decrease.

In an embodiment, based on the first graph 200, a difference between the first graph 200 and luminance of an image may be a 'degree of loss'. In a case where a degree of loss when a driving current has a first magnitude is a first degree of loss 230 and a degree of loss when a driving current has a second magnitude greater than the first magnitude is a second degree of loss 240, the second degree of loss 240 may be greater than the first degree of loss 230.

In an embodiment, luminance of an image 120 may be determined by a length of a turn-on period 132 and a magnitude 133 of a driving current in the turn-on period 132.

For example, the turn-on period 132 may be a period for which the image 120 is displayed within one frame. A turn-off period may be a period for which the image 120 is not displayed within one frame. Accordingly, as a length of a turn-on period 132 increases, a period for which an image 120 is displayed within one frame may also increase and luminance of an image 120 displayed through a plurality of frames may increase. In an embodiment, as a duty ratio increases, luminance of an image 120 may increase.

A magnitude 133 of a driving current in a turn-on period 132 may determine an intensity of luminance of an image displayed in the turn-on period 132. Accordingly, as the magnitude 133 of the driving current increases, luminance of an image 120 for a period for which the image 120 is displayed within one frame may increase, and as a result, luminance of an image 120 displayed for a plurality of frames may increase.

In an embodiment, power consumption of the display device 100 may be determined by a product of a length of a turn-on period 132 and a magnitude 133 of a driving current in the turn-on period 132. Accordingly, the display device 100 may control luminance of an image 120 displayed on the display 110 and power consumption of the display device 100 by adjusting a length of a turn-on period 132 and a magnitude 133 of a driving current in the turn-on period 132. The display device 100 may control luminance of an image 120 displayed on the display 110 and power consumption of the display device 100 by adjusting a duty ratio and a magnitude 133 of a driving current. Hereinafter, for convenience of description, adjusting a length of a turn-on period 132 will be described as adjusting a duty ratio.

In an embodiment, the display device 100 may adjust a duty ratio and a magnitude of a driving current in correspondence to the adjusted duty ratio in order to maintain constant power consumption and provide an image 120 with a uniform luminance. In an embodiment, the display device 100 may determine a duty ratio by analyzing an image 120 to be displayed. In an embodiment, the display device 100 may adjust a duty ratio and a magnitude 133 of a driving current to have a constant area 134 of a turn-on period in order to maintain constant power consumption.

In an embodiment, when a duty ratio determined according to an image 120 to be displayed decreases, a magnitude 133 of a driving current provided to the display 100 may increase. In an embodiment, when a duty ratio determined according to an image 120 to be displayed increases, a magnitude 133 of a driving current provided to the display 100 may decrease.

Referring to the first graph 200 and the second graph 210, due to a difference between the first degree of loss 230 and the second degree of loss 240, luminance of when a duty ratio is low and a magnitude 133 of a driving current is great may be lower than luminance of when a duty ratio is high and a magnitude 133 of a driving current is small, at the same power consumption. Accordingly, even when the same power consumption is required to drive the display 110, luminance of an image 120 displayed on the display 110 may vary.

In an embodiment, the display device 100 may adjust a duty ratio and a magnitude 133 of a driving current such that an image 120 displayed on the display 110 has a uniform luminance. In this case, at the same luminance of the image 120, power consumption of when a duty ratio is low and a magnitude 133 of a driving current 133 is great may be higher than power consumption of when a duty ratio is high and a magnitude 133 of a driving current is small. Accordingly, when the display 110 operates to display an image 120 with a uniform luminance, power consumption of the display 110 may vary.

Accordingly, the display device 100 according to the present disclosure may calculate a duty ratio by analyzing an input image and calculate a first duty margin for a turn-on period within one frame 131 based on the calculated duty ratio and a preset target duty ratio.

The display device 100 according to the present disclosure may calculate a second duty margin using the calculated duty ratio and a target duty ratio determined by a preset relational expression between a driving duty ratio and a driving current of the display 110. The second duty margin may be a margin for a driving current corresponding to the calculated duty ratio and a minimum current required to drive the display 110.

In an embodiment, the display device 100 may determine a correcting duty margin by comparing the first duty margin with the second duty margin. The display device 100 may drive the display 110 with a final duty ratio determined using the correcting duty margin and a final driving current 135 determined to correspond to the final duty ratio.

In this case, the final duty ratio may be higher than the duty ratio determined by analyzing the input image. A length of a turn-on period 136 according to the final duty ratio may be longer than a length of a turn-on period 132 according to the duty ratio determined by analyzing the input image. A magnitude 137 of the final driving current may be less than a magnitude 133 of the driving current corresponding to the duty ratio determined by analyzing the input image.

Accordingly, when the display device 100 operates such that an image displayed on the display 110 has a uniform luminance, power consumption of when the display device 100 provides the final driving current 135 to the display 110 may be lower than power consumption of when the display device 100 provides the driving current 130 to the display 110. In an embodiment, an area 138 of the turn-on period 136, which is a product of the length of the turn-on period 136 of the final driving current 135 and the magnitude 137 of the final driving current in the turn-on period 136, may be smaller than an area 134 of the driving current 130. Accordingly, the display device 100 may control the display 110 to display an image 120 having a uniform luminance with low power consumption.

When the display device 100 operates to maintain constant power consumption, luminance of an image 120 of when the display device 100 provides the final driving current 135 to the display 110 may be higher than luminance of the image 120 of when the display device 100 provides the driving current 130 to the display 110. In this case, in an embodiment, an area 138 of a turn-on period of the final driving current 135 may be equal to an area 134 of a turn-on period of the driving current 130. Accordingly, the display device 100 may control the display 110 to display an image 120 having a high luminance with the same power consumption.

Effects that may be achieved by the present disclosure are not limited to the above-mentioned effects, and other effects not mentioned will be clearly understood by one of ordinary skill in the technical field to which the present disclosure belongs from the following descriptions.

In an embodiment, the display 110 may include a backlight that provides light. In an embodiment, the display 110 may display an image 110 using light provided by the backlight. In this case, the driving current 130 and the final driving current 135 may be currents for controlling the backlight. The display device 100 may provide the driving current 130 or the final driving current 135 to the backlight in order to provide light for displaying the image 110.

In FIG. 1, the display device 100 is shown as providing the driving current 130 or the final driving current 135 to the display 110. However, the present disclosure is not limited thereto. According to a type of the display 110 for displaying an image 120 and an operation method of the display device 100, a waveform shown in FIG. 1 may be a waveform corresponding to a driving voltage or a final driving voltage that the display device 100 provides to the display 110. In this case, a duty ratio may be a ratio of a length of a turn-on period of the driving voltage or the final driving voltage to a length of one frame 131. An area of a turn-on period may be a product of a length of the turn-on period and a magnitude of the driving voltage in the turn-on period.

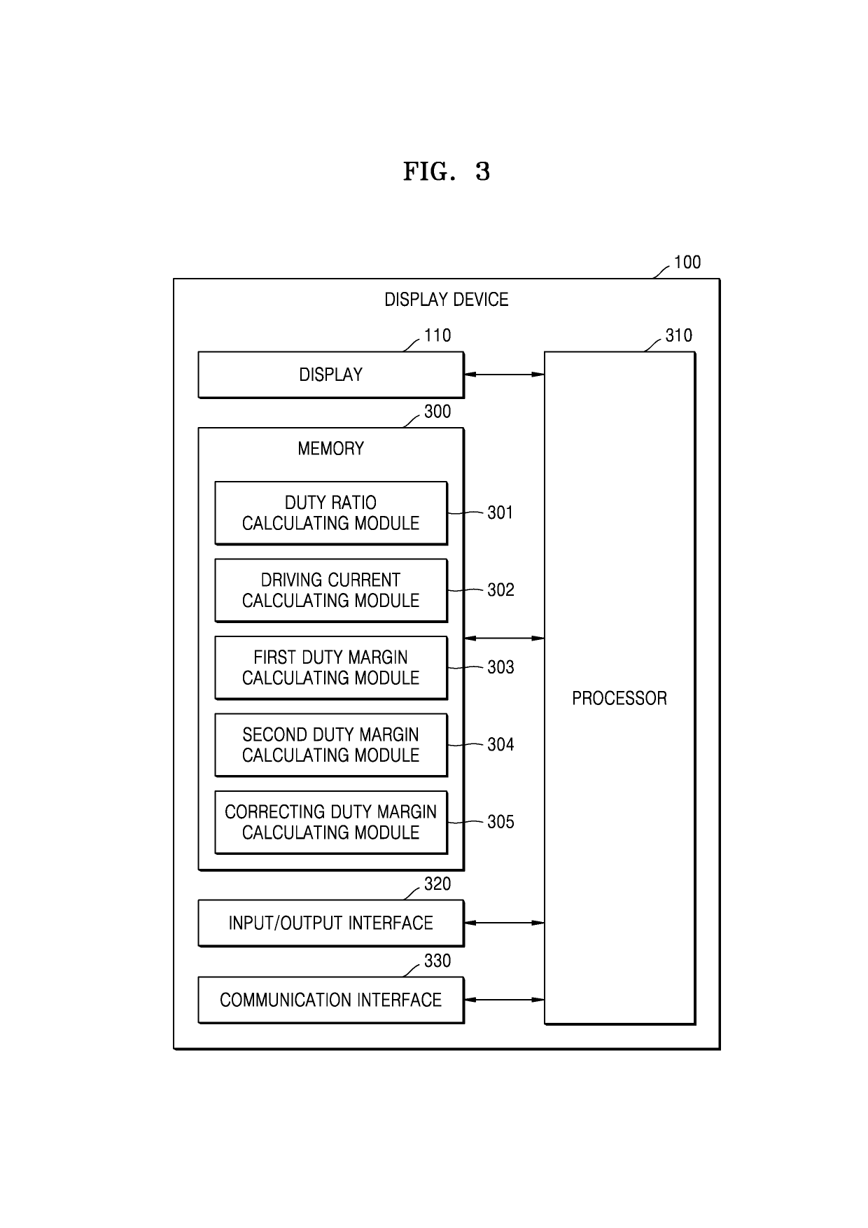

FIG. 3 is a block diagram illustrating an example configuration of a display device according to various embodiments.

Referring to FIGS. 1 and 3, in an embodiment, the display device 100 may include the display 110, memory 300, at least one processor (e.g., including processing circuitry) 310, an input/output interface (e.g., including circuitry) 320, and a communication interface (e.g., including communication circuitry) 330. However, all components shown in FIG. 3 may not be essential components. The display device 100 may be implemented by more or fewer components than those shown in FIG. 3. The display 110, the memory 300, the at least one processor 310, the input/output interface 320, and the communication interface 330 may be electrically and/or physically connected to each other.

In an embodiment, the display 110 may include a liquid crystal display. In an embodiment, the display 110 may include a backlight and a color filter. In an embodiment, the backlight may generate light. Light generated from the backlight may be provided as an image 120 to a user via the color filter. The display 110 may provide the image 120 to the user through the backlight and the color filter. In an embodiment, the backlight may include a light emitting diode. However, the present disclosure is not limited thereto and the backlight may include components known to perform a function of generating light.

However, the present disclosure is not limited thereto, and the display 110 may include a display that generates light by itself to provide an image 120, such as an organic light emitting diodes display or an inorganic light emitting diodes display. In this case, the display 110 may not include a backlight. However, the present disclosure is not limited thereto and the display 110 may include other types of displays capable of providing an image 120 to the user. Also, according to an operation method of the display 110, the organic light emitting diodes display or the inorganic light emitting diodes display may also include a backlight.

In an embodiment, the display 110 may be divided into a plurality of blocks and driven. The at least one processor 310 may control the display 110 to be divided into a plurality of blocks and driven to display an image 120. In an embodiment, in a case where the display 110 includes a plurality of pixels, each of the plurality of blocks may correspond to at least one pixel.

In an embodiment, in a case where the display 110 includes a backlight, the backlight may be divided into a plurality of blocks and driven. The at least one processor 310 may control the backlight to be divided into a plurality of blocks and driven to display an image 120. In an embodiment, in a case where the backlight includes a plurality of light sources (for example, light emitting diodes), each of the plurality of blocks may correspond to at least one light source.

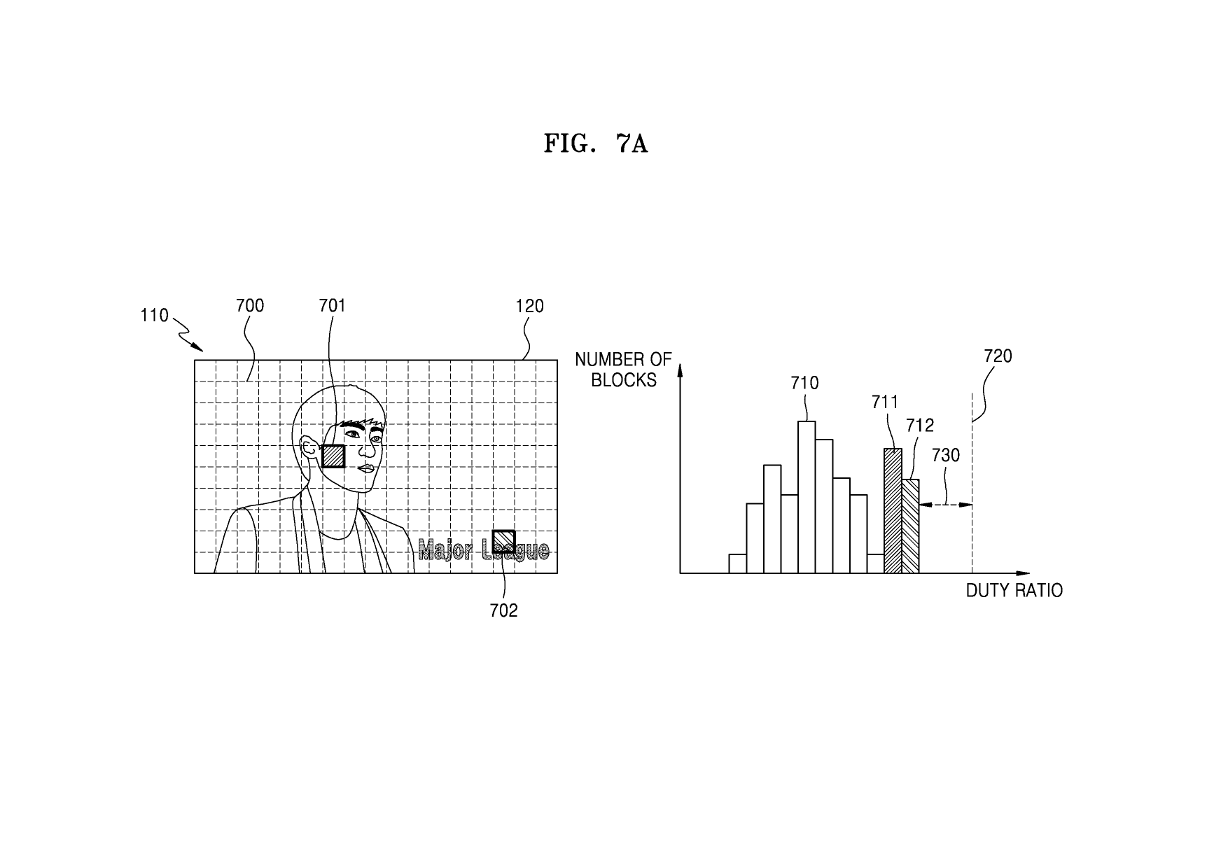

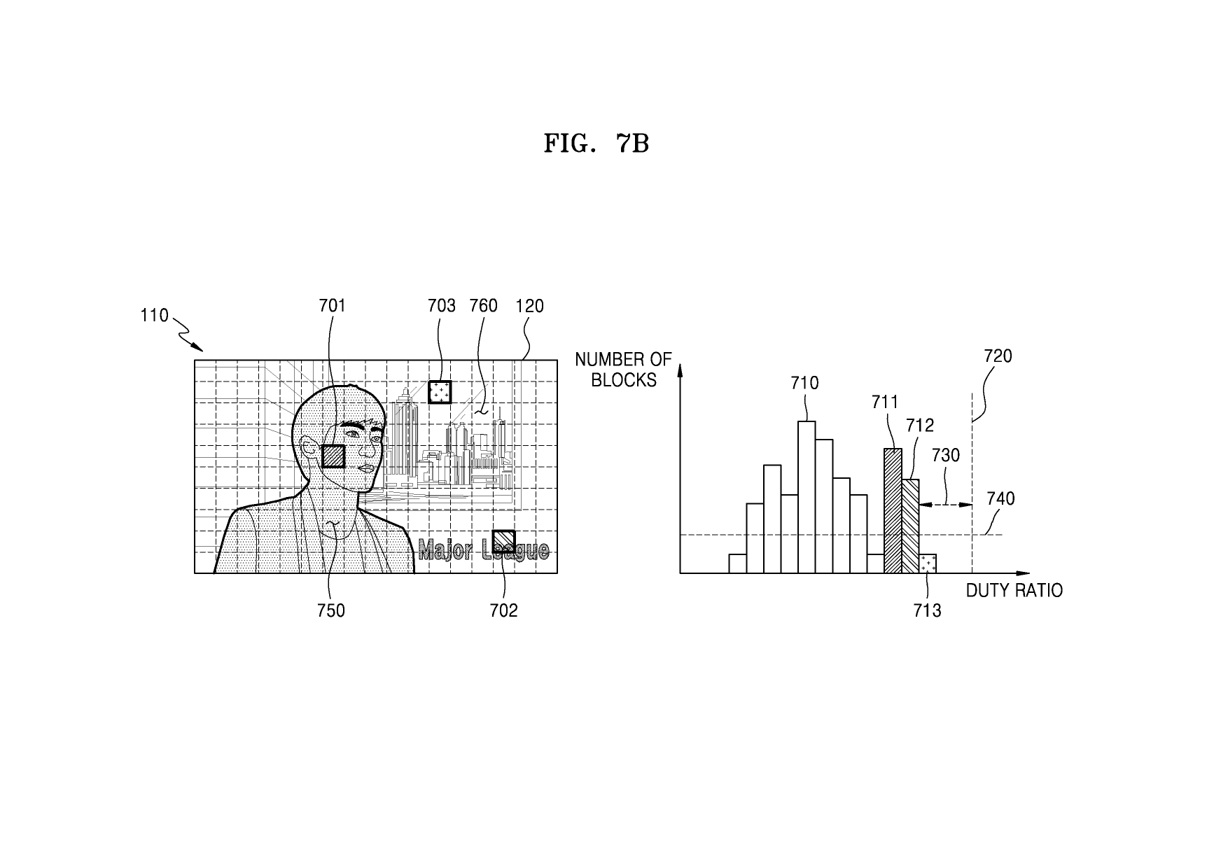

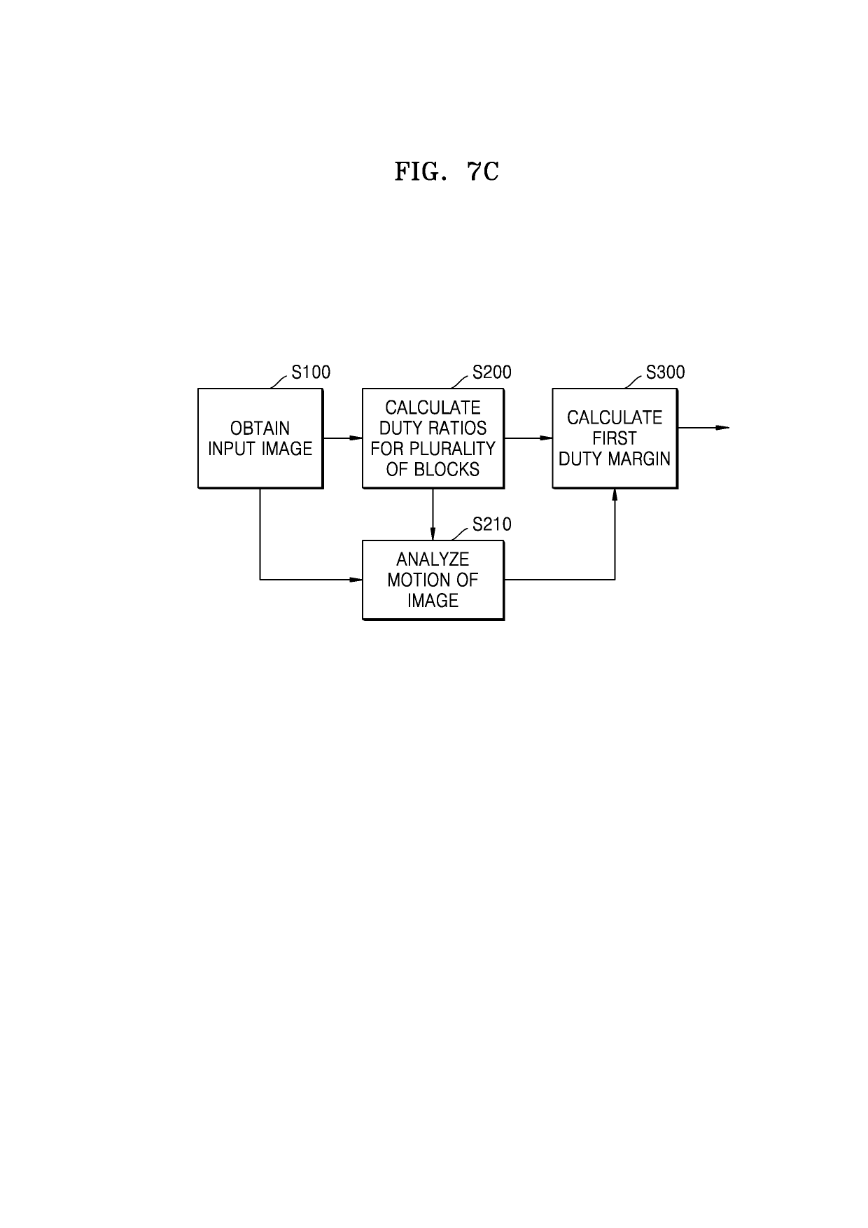

Hereinafter, the plurality of blocks will be described with reference to FIGS. 7A and 7B, below.

In an embodiment, the memory 300 may include at least one of a flash memory type, a hard disk type, a multimedia card micro type, card type memory (for example, Secure Digital (SD) or eXtream Digital (XD) memory, etc.), Random Access Memory (RAM), Static Random Access Memory (SRAM), Read-Only Memory (ROM), Electrically Erasable Programmable Read-Only Memory (EEPROM), Programmable Read-Only Memory (PROM), Mask ROM, Flash ROM, a hard disk drive (HDD), or a solid state drive (SSD). The memory 300 may store instructions or program codes for performing functions or operations of the display device 100. Instructions, algorithms, data structures, program codes, and application programs stored in the memory 300 may be implemented in a programming or scripting language, such as, for example, C, C++, Java, assembler, etc.

In an embodiment, various kinds of modules capable of being used to provide an image 120 to a user through the display 110 may be stored in the memory 300. Various kinds of modules capable of being used to control a length of a driving duty and an intensity of a driving current for driving the display 110 may be stored in the memory 300.

In an embodiment, a duty ratio calculating module 301, a driving current calculating module 302, a first duty margin calculating module 303, a second duty margin calculating module 304, a correcting duty margin calculating module 305, each of which may include various executable program instruction, may be stored in the memory 300. However, all the modules shown in FIG. 3 may not be essential modules. More or fewer modules than those shown in FIG. 3 may be stored in the memory 300.

The 'module' included in the memory 300 may refer, for example, to a unit that processes a function or operation that is performed by the at least one processor 310. The 'module' included in the memory 300 may be implemented as software, such as instructions, algorithms, data structures, or program codes.

In an embodiment, the duty cycle calculating module 301 may be configured with instructions or program codes related to an operation or function of calculating a plurality of duty ratios at which the plurality of blocks of the display 110 are respectively driven, based on an input image obtained through the input/output interface 320.

In an embodiment, each of the plurality of blocks of the display 110 may be controlled to display an image 120 at a duty ratio determined based on an input image corresponding to each of the plurality of blocks. In an embodiment, the duty ratio calculating module 301 may be configured with instructions or program codes related to an operation or function of calculating a plurality of duty ratios at which the plurality of blocks of the display 110, each corresponding to an input image, are respectively driven, based on a gradation, contrast ratio, color, or sharpness of the input image, an object and background included in the input image, a shape of the object, or a position of the object.

In an embodiment, the duty ratio calculating module 301 may be configured with instructions or program codes related to an operation or function of calculating, as a high duty ratio, a duty ratio of a block corresponding to a region including a high gradation in the input image among the plurality of blocks and calculating, as a low duty ratio, a duty ratio of a block corresponding to a region including a low gradation in the input image.

However, the present disclosure is not limited thereto, and the duty ratio calculating module 301 may be configured with instructions or program codes related to an operation or function of calculating a plurality of duty ratios at which the plurality of blocks of the display 110 are respectively driven by analyzing an input image in order to improve image quality of the input image by utilizing a fact that a time for which an image is displayed on the display 110 within one frame depends on a duty ratio.

In an embodiment, the duty ratio calculating module 301 may be configured with instructions or program codes related to an operation or function of selecting a second reference duty ratio from among the plurality of calculated duty ratios. The duty ratio calculating module 301 may be configured with instructions or program codes related to an operation or function of selecting, as the second reference duty ratio, a highest duty ratio among the plurality of calculated duty ratios.

However, the present disclosure is not limited thereto, and the duty ratio calculating module 301 may be configured with instructions or program codes related to an operation or function of grouping the plurality of blocks into a plurality of block groups each having the same duty ratio based on the plurality of calculated duty ratios, and selecting, as the second reference duty ratio, a highest duty ratio among duty ratios corresponding to a plurality of block groups, in each of which the number of one or more blocks is equal to or more than a preset threshold value, among the plurality of block groups.

In an embodiment, the at least one processor 310 may include various processing circuitry and execute instructions or program codes of the duty ratio calculating module 301 to calculate the plurality of duty ratios at which the plurality of blocks included in the display 110 are respectively driven within one frame based on the obtained input image.

In an embodiment, the at least one processor 310 may execute instructions or program codes of the duty ratio calculating module 301 to select the second reference duty ratio from among the plurality of calculated duty ratios. The at least one processor 310 may select the highest duty ratio among the plurality of calculated duty ratios as the second reference duty ratio.

The at least one processor 310 may group the plurality of blocks into the blocks each having the same duty ratio based on the plurality of calculated duty ratios, and select, as the second reference duty ratio, the highest duty ratio among duty ratios corresponding to the blocks, in each of which the number of blocks is equal to or more than the preset threshold value, among the blocks.

In an embodiment, the driving current calculating module 302 may be configured with instructions or program codes related to an operation or function of calculating a driving current corresponding to the second reference duty ratio using a preset relational expression between a driving duty ratio and a driving current of the display 110.

In an embodiment, the preset relational expression between the driving duty ratio and driving current of the display 110 may include a relational expression set to a relationship between a driving duty ratio and a driving current for displaying an image 120 having a specific luminance by considering specifications such as a resolution and driving frequency of the display 110, rated power of the display device 100, or power consumption of the display device 100. However, the present disclosure is not limited thereto, and the relational expression may include a relational expression set to a relationship between a driving duty ratio and a driving current for displaying an image 120 with specific power consumption.

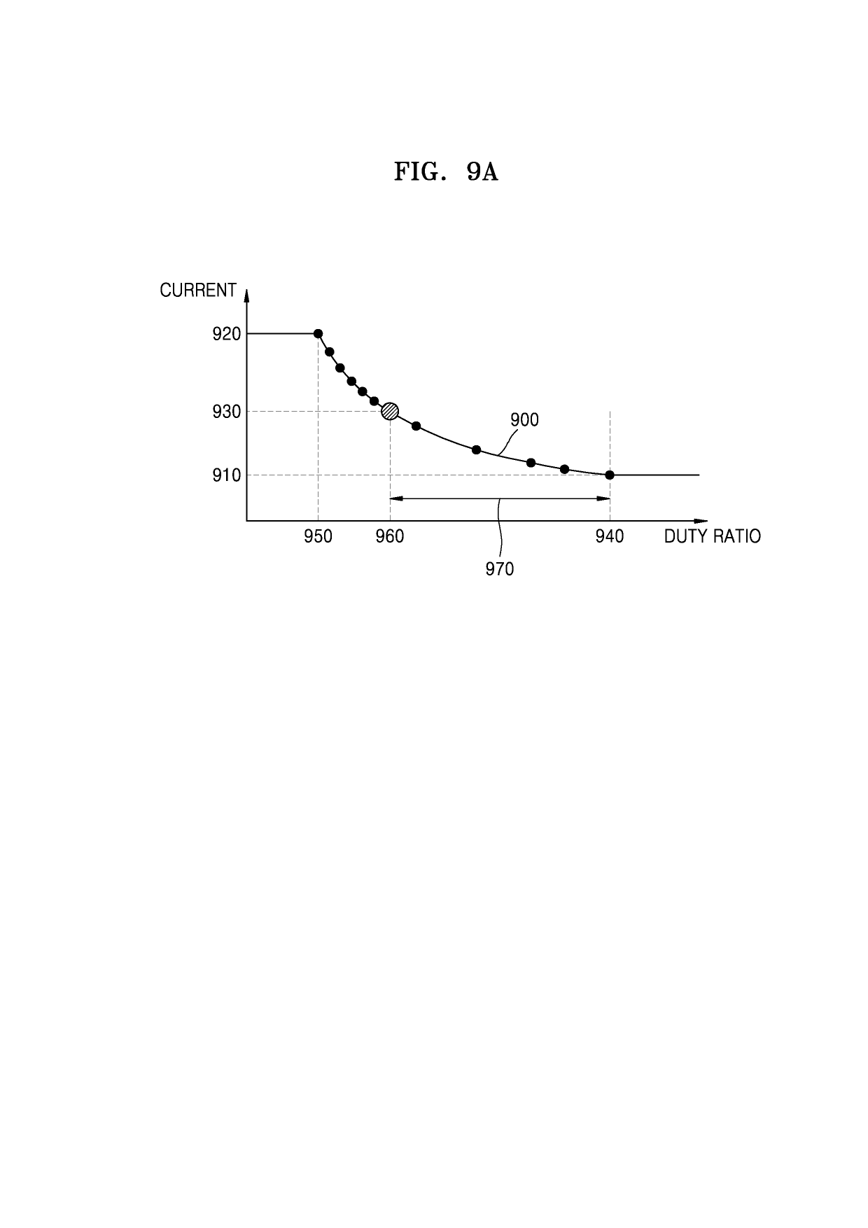

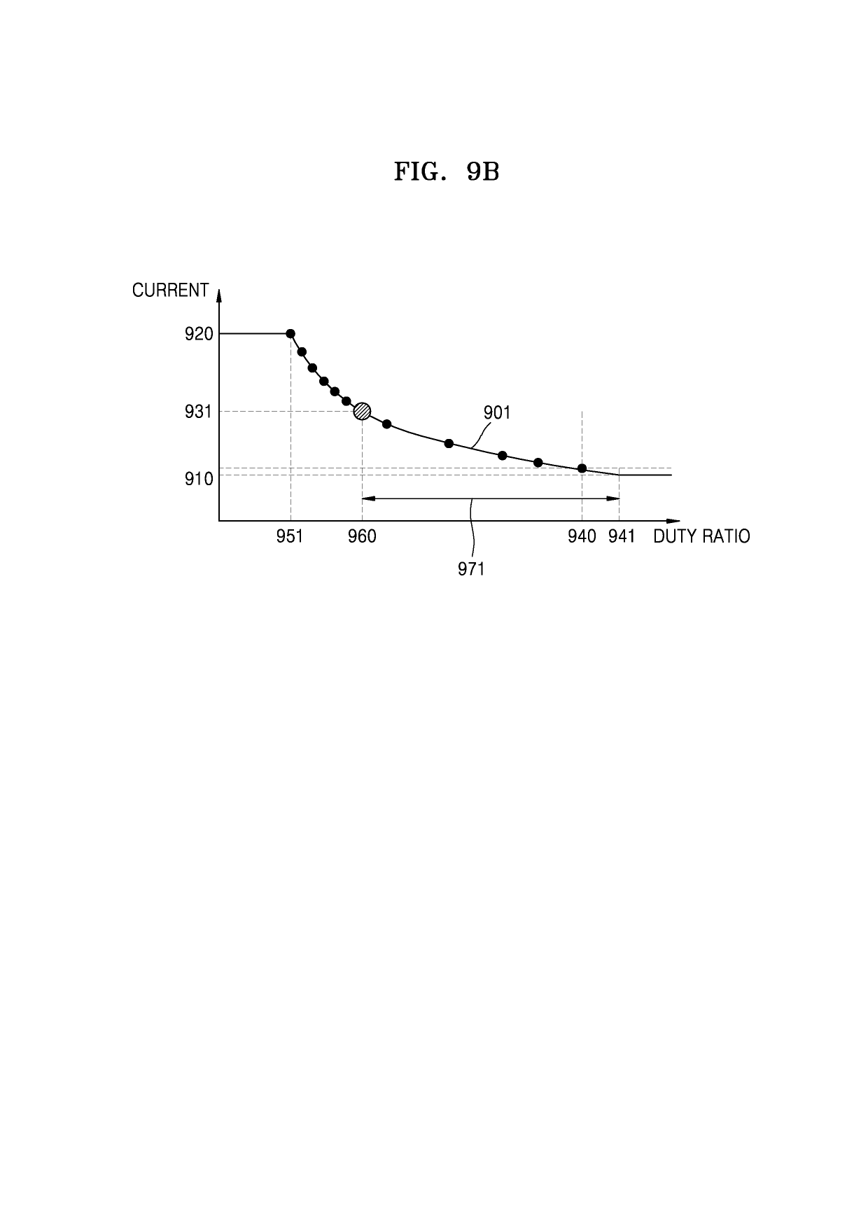

In an embodiment, according to the relational expression, after a driving duty ratio of the display 110 is determined, a corresponding driving current may be determined. The display 110 may be controlled by the driving duty ratio and driving current determined according to the relational expression. Hereinafter, the relational expression will be described with reference to FIGS. 9A and 9B.

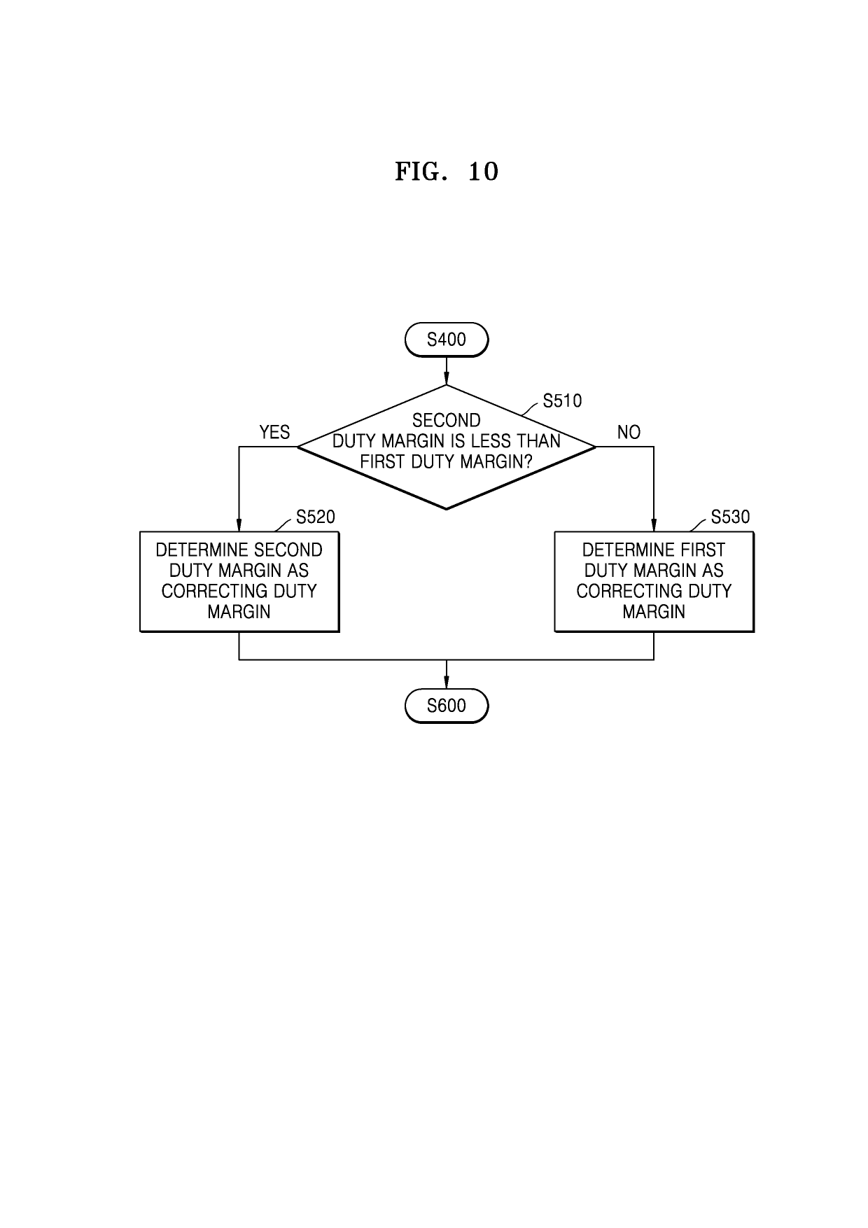

In an embodiment, the driving current calculating module 302 may be configured with instructions or program codes related to an operation or function of calculating a final driving current based on a correcting duty margin and a driving current calculated to correspond to the second reference duty ratio using a relational expression. In an embodiment, the driving current calculating module 302 may be configured with instructions or program codes related to an operation or function of calculating a final driving current determined to correspond to a plurality of final duty ratios determined using the correcting duty margin, using the relational expression. An operation of calculating the final driving current will be described with reference to FIGS. 10 to 12, below.

In an embodiment, the at least one processor 310 may execute instructions or program codes of the driving current calculating module 302 to calculate the driving current corresponding to the second reference duty ratio using the relational expression. The at least one processor 310 may execute instructions or program codes of the driving current calculating module 302 to calculate the final driving current corresponding to the plurality of final driving duty ratios using the correcting duty margin and the driving current calculated to correspond to the second reference duty ratio using the relational expression.

In an embodiment, the first duty margin calculating module 303 may be configured with instructions or program codes related to an operation or function of calculating a first duty margin using a first target duty ratio set in advance and a first reference duty ratio calculated. In an embodiment, the first duty margin calculating module 303 may be configured with instructions or program codes related to an operation or function of calculating, as the first duty margin, a difference between the first target duty ratio set in advance and the first reference duty ratio calculated.

In an embodiment, the first target duty ratio may be a ratio set to a highest duty ratio at which the display 110 is capable of being driven within one frame. In this case, the first target duty ratio may be set according to specifications of the display 110. Also, the first target duty ratio may be a ratio set when the display device 100 is manufactured.

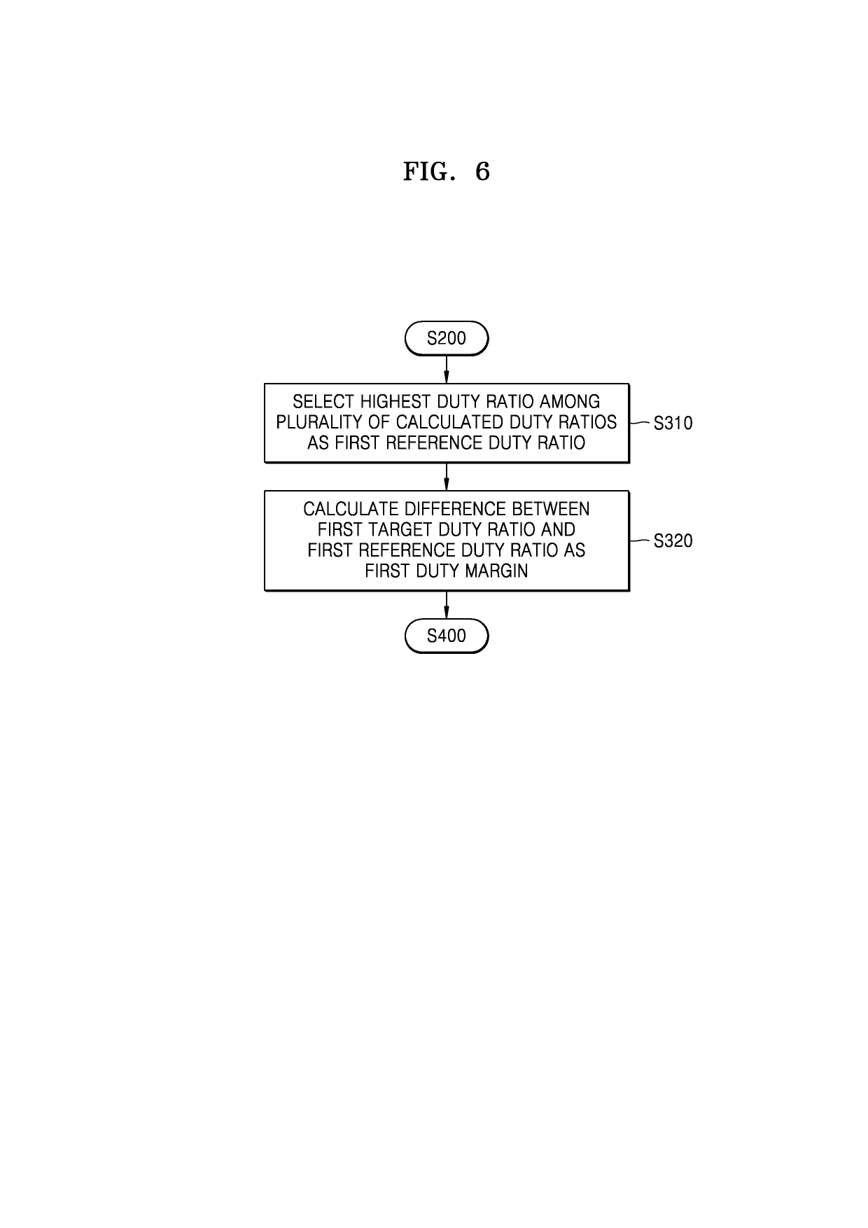

In an embodiment, the at least one processor 310 may execute instructions or program codes of the first duty margin calculating module 303 to calculate the first duty margin using the first target duty ratio set in advance and the first reference duty ratio calculated. The at least one processor 310 may calculate the difference between the first target duty ratio set in advance and the first reference duty ratio calculated, as the first duty margin. An operation of calculating the first duty margin will be described in greater detail below with reference to FIGS. 6 to 7C.

In an embodiment, the second duty margin calculating module 304 may be configured with instructions or program codes related to an operation or function of calculating a second duty margin using the second reference duty ratio and a second target duty ratio determined by a preset relational expression. In an embodiment, the second duty margin calculating module 304 may be configured with instructions or program codes related to an operation or function of calculating, as the second duty margin, a difference between the second target duty ratio and the second reference duty ratio.

In an embodiment, the relational expression may include a minimum driving current for driving the display 110 and a minimum driving duty ratio corresponding to the minimum driving current. Here, the minimum driving current may be a minimum driving current that needs to be provided to display an image 120 on the display according to specifications of the display 110. In an embodiment, the minimum driving current may be a current for operating the display 110. The minimum driving current and the minimum driving duty ratio may be ratios set when the display device 100 is manufactured.

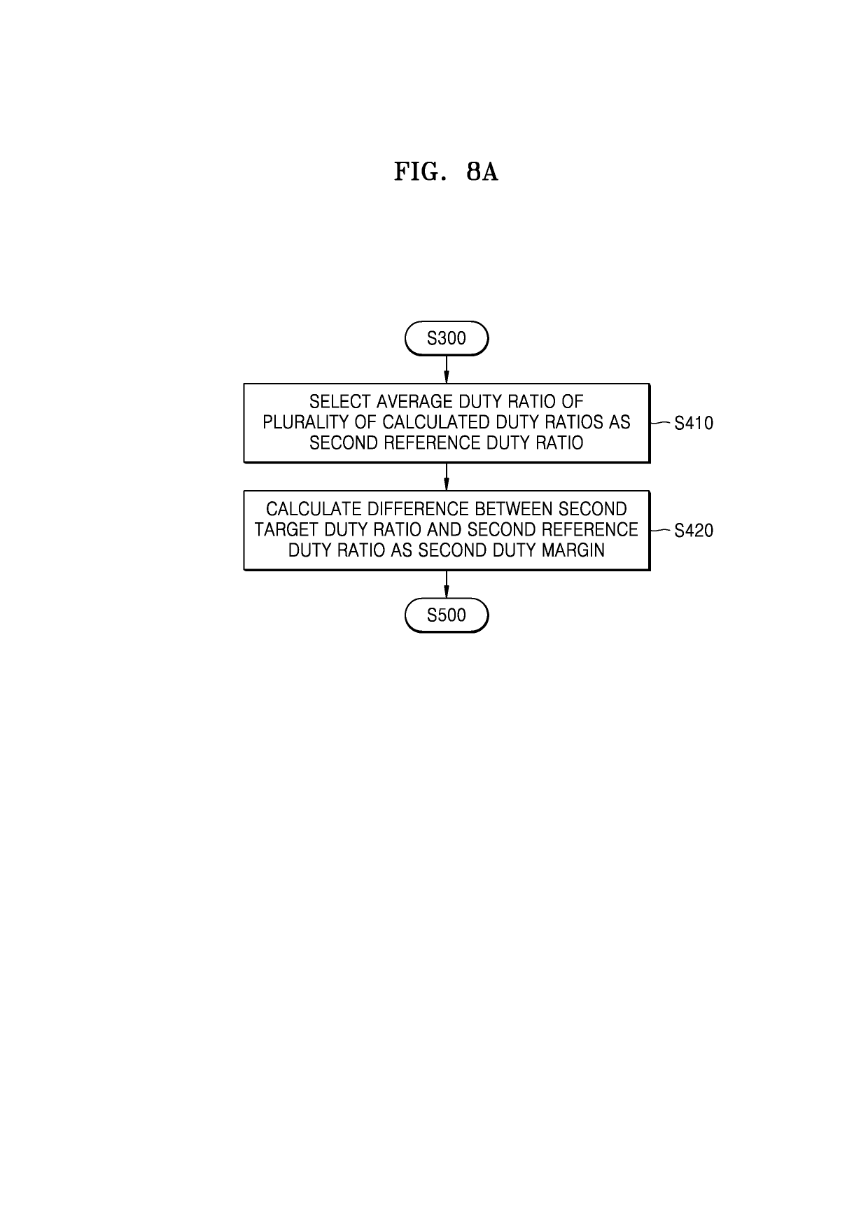

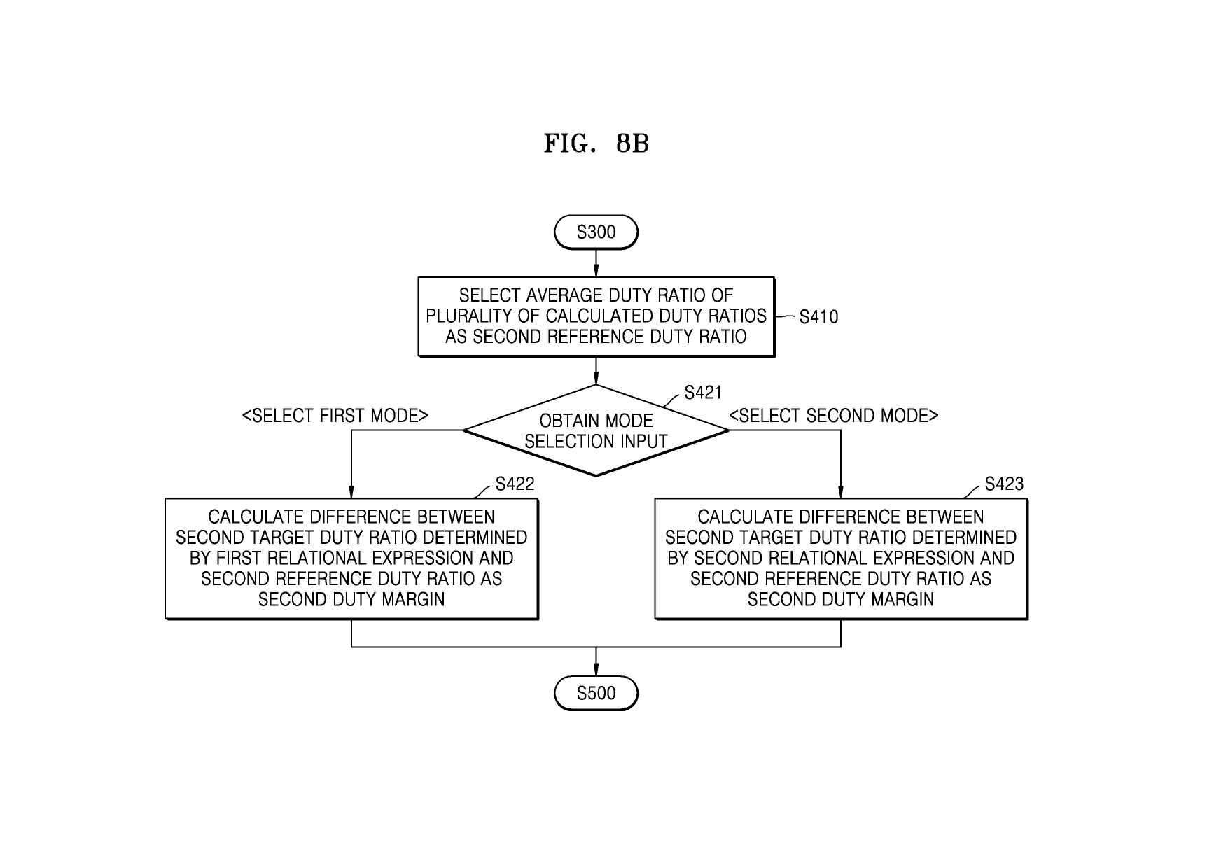

In an embodiment, the at least one processor 310 may execute instructions or program codes of the second duty margin calculating module 304 to calculate the second duty margin using the second reference duty ratio and the second target duty ratio determined by the preset relational expression. The at least one processor 310 may calculate the difference between the second target duty ratio and the second reference duty ratio, as the second duty margin. An operation of calculating the second duty margin will be described in greater detail below with reference to FIGS. 8A to 9B.

In an embodiment, the duty margin calculating module 305 may be configured with instructions or program codes related to an operation or function of determining a correcting duty margin by comparing the first duty margin with the second duty margin. In an embodiment, the correcting duty margin calculating module 305 may be configured with instructions or program codes related to an operation or function of comparing the first duty margin with the second duty margin, and when the first duty margin is equal to or less than the second duty margin, determining the first duty margin as the correcting duty margin. The correcting duty margin calculating module 305 may be configured with instructions or program codes related to an operation or function of comparing the first duty margin with the second duty margin, and when the second duty margin is less than the first duty margin, determining the second duty margin as the correcting duty margin.

In an embodiment, the at least one processor 310 may execute instructions or program codes of the correcting duty margin calculating module 305 to compare the first duty margin with the second duty margin and determine the correcting duty margin. The at least one processor 310 may execute instructions or program codes of the correcting duty margin calculating module 305 to compare the first duty margin with the second duty margin, and when the first duty margin is equal to or less than the second duty margin, determine the first duty margin as the correcting duty margin. The at least one processor 310 may compare the first duty margin with the second duty margin, and when the second duty margin is less than the first duty margin, the at least one processor 310 may determine the second duty margin as the correcting duty margin.

In an embodiment, the at least one processor 310 may be configured as at least one of a Central Processing Unit, a microprocessor, a Graphic Processing Unit, an Application Processor (AP), an Application Specific Integrated Circuits (ASICs), a Digital Signal Processor (DSPs), a Digital Signal Processing Device (DSPDs), a Programmable Logic Device (PLDs), a Field Programmable Gate Array (FPGAs), Neural Processing Unit, or an artificial intelligence (AI) processor designed with a hardware structure specialized for learning and processing an AI model, but is not limited thereto. Thus, the at least one processor 310 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

In an embodiment, the at least one processor 310 may be configured as circuitry such as System on Chip (SoC) or Integrated Circuit (IC).

In an embodiment, the at least one processor 310 may execute various kinds of modules stored in the memory 300. In an embodiment, the at least one processor 310 may execute the duty ratio calculating module 301, the driving current calculating module 302, the first duty margin calculating module 303, the second duty margin calculating module 304, and the correction duty margin calculating module 305, stored in the memory 300. In an embodiment, the at least one processor 310 may execute at least one instruction configuring the various kinds of modules stored in the memory 300.

In an embodiment, the at least one processor 310 may execute the various kinds of modules stored in the memory 300. The at least one processor 310 may execute at least one instruction configuring the various types of modules stored in the memory 300. By executing a program or at least one instruction stored in the memory 300, the at least one processor 310 may process data according to a predefined operation rule.

In an embodiment of the present disclosure, the at least one processor 310 may execute at least one module among the duty ratio calculating module 301, the driving current calculating module 302, the first duty margin calculating module 303, the second duty margin calculating module 304, or the correcting duty margin calculating module 305, stored in the memory 300.

In an embodiment of the present disclosure, the at least one processor 310 may include a plurality of processors. In an embodiment of the present disclosure, at least one module among the duty ratio calculating module 301, the driving current calculating module 302, the first duty margin calculating module 303, the second duty margin calculating module 304, or the correcting duty margin calculating module 305, stored in the memory 300 may be executed by any processor among the plurality of processors.

In an embodiment, the input/output interface 320 may include various circuitry and receive an input image from a surrounding electronic device, etc., under control by the at least one processor 310. In an embodiment, the input image may include a still image or a moving image. The input/output interface 320 may receive audio (for example, a voice signal, a music signal, etc.) and additional information, etc. from an external device, etc., under control by the at least one processor 310. The input/output interface 320 may include at least one of a High-Definition Multimedia Interface (HDMI) port, a component jack, a PC port, or a USB port. However, the present disclosure is not limited thereto, and the input/output interface 320 may include various types of interfaces capable of receiving an input image from surrounding electronic devices.

In an embodiment, the communication interface 330 may include various communication circuitry and perform data communication with an external server (not shown) under control by the at least one processor 310. The communication interface 330 may perform data communication not only with an external server but also with other surrounding electronic devices (not shown). The communication interface 330 may perform data communication with a server or surrounding electronic devices using at least one of data communication methods including, for example, Wired LAN, Wireless LAN, Wi-Fi, Bluetooth, zigbee, Wi-Fi Direct (WFD), infrared Data Association (IrDA), Bluetooth Low Energy (BLE), Near Field Communication (NFC), Wireless Broadband Internet (Wibro), World Interoperability for Microwave Access (WiMAX), Shared Wireless Access Protocol (SWAP), Wireless Gigabit Alliance (WiGig), and RF communication.

In an embodiment, the at least one processor 310 may receive a pre-calculated first relational expression, a pre-calculated second relational expression, a preset first target duty ratio, and a preset second target duty ratio from an external server or surrounding electronic devices through the communication interface 330.

The present disclosure is not limited thereto, and the at least one processor 310 may receive an input image from an external server (for example, a web server, a cloud service, etc.) through the communication interface 330.

In an embodiment, the display device 100 may further include a user interface including various circuitry for obtaining a user input. In an embodiment, the user interface may include a touch portion, a push button, a voice recognition portion, a gesture recognition portion, and the like. In an embodiment, the display device 100 may obtain a user input provided by a user through the user interface. In an embodiment, the display device 100 may obtain a user input from a user who touches the user interface, presses the user interface, provides a voice to the user interface, or makes a gesture such as a hand gesture on the user interface. In an embodiment, a user may provide, through the user interface, a user input of selecting any operation mode of a first mode or a second mode for operations of the display device 100, which will be described below. The display device 100 may perform an operation by selecting any mode of the first mode or the second mode based on the user input obtained through the user interface.

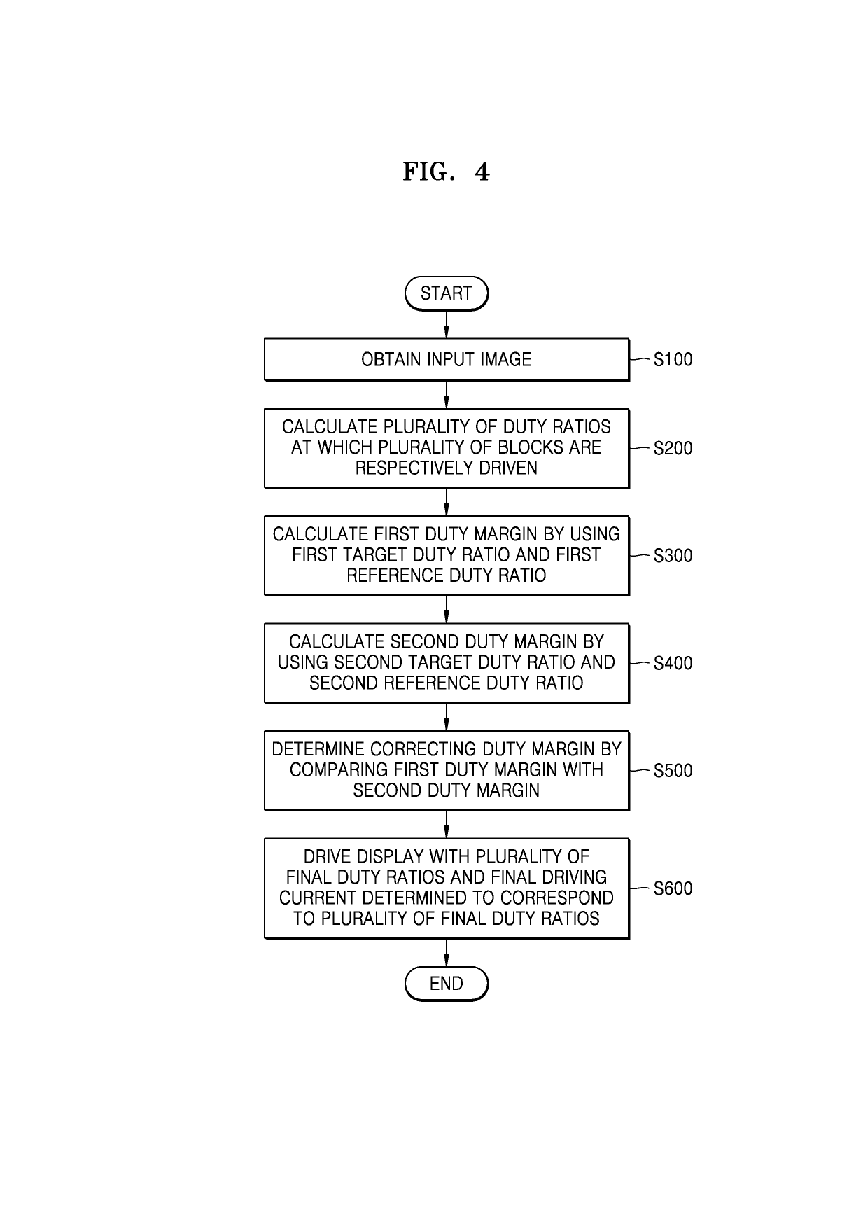

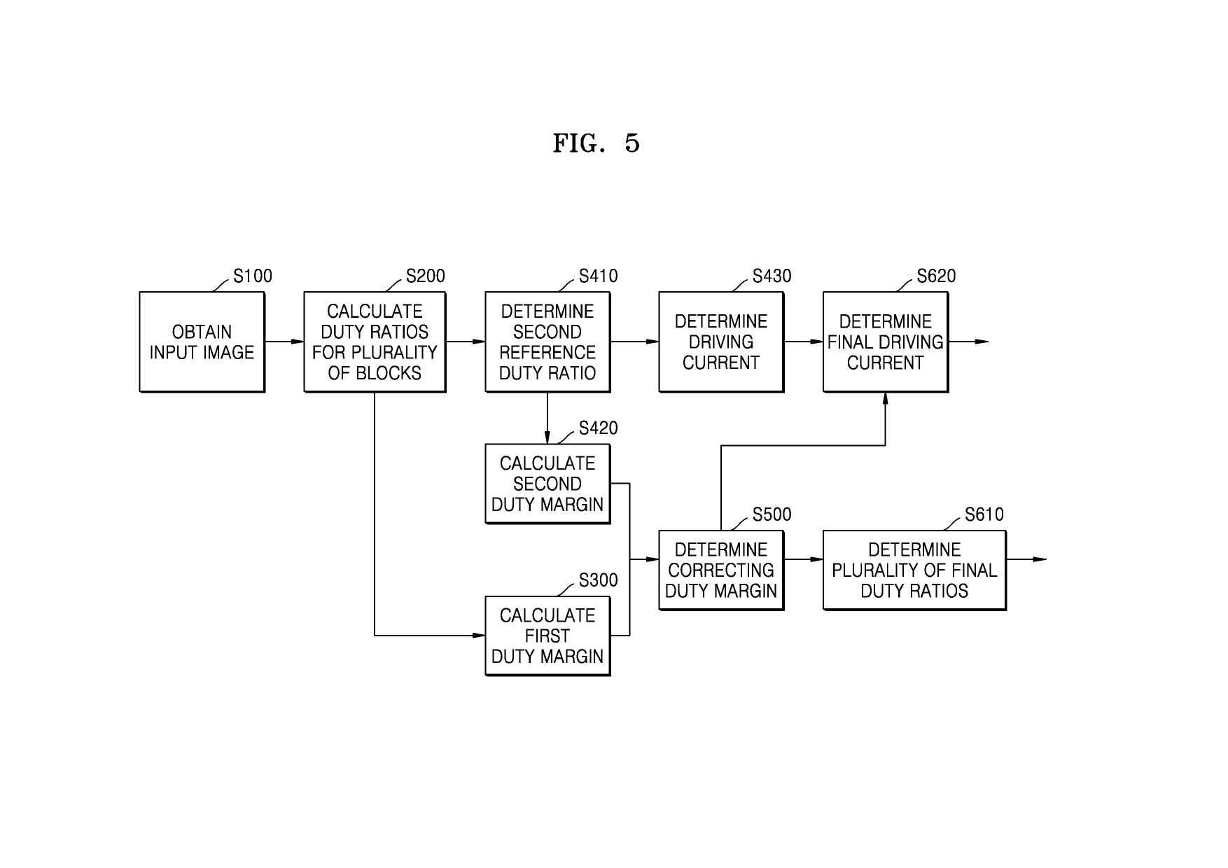

FIG. 4 is a flowchart illustrating an example operation of a display device according to various embodiments. FIG. 5 is a flowchart illustrating an example operation of a display device according to various embodiments.

Referring to FIGS. 1, 2, 4, and 5, in an embodiment, a method of operating the display device 100 may include operation S100 of obtaining an input image. According to an embodiment, in operation S100 of obtaining the input image, the at least one processor 310 may obtain the input image through the input/output interface 320. However, the present disclosure is not limited thereto, and the at least one processor 310 may obtain the input image through the communication interface 330. Also, the at least one processor 310 may read the input image stored in the memory 300.

In an embodiment, the operation method of the display device 100 may include operation S200 of calculating a plurality of duty ratios at which a plurality of blocks of the display 110, which are divided and driven within one frame 131, are respectively driven, based on the obtained input image.

According to an embodiment, in operation S200 of calculating the plurality of duty ratios, the at least one processor 310 may execute instructions or program codes of the duty ratio calculating module 301 to calculate the plurality of duty ratios at which the plurality of blocks of the display 110, which are divided and driven within the one frame 131, are respectively driven.

In an embodiment, the operation method of the display device 100 may include operation S300 of calculating a first duty margin using a preset (e.g., specified) first target duty ratio and a first reference duty ratio selected from among the plurality of calculated duty ratios.

According to an embodiment, in operation S300 of calculating the first duty margin, the at least one processor 310 may execute instructions and program codes of the first duty margin calculating module 303 to calculate the first duty margin using the preset first target duty ratio and the first reference duty ratio selected from among the plurality of calculated duty ratios. Operation S300 of calculating the first duty margin will be described in greater detail below with reference to FIGS. 6 to 7.

In an embodiment, the operation method of the display device 100 may include operation S400 of calculating a second duty margin using a second target duty ratio determined by a preset relational expression between a driving duty ratio and a driving current of the display 110 and a second reference duty ratio selected from among the plurality of calculated duty ratios.

Referring to FIG. 5, in an embodiment, operation S400 of calculating the second duty margin may include operation S410 of selecting an average duty ratio of the plurality of calculated duty ratios as the second reference duty ratio. Operation S400 of calculating the second duty margin may include operation S420 of calculating a difference between the second target duty ratio and the second reference duty ratio as the second duty margin.

According to an embodiment, in operation S400 of calculating the second duty margin, the at least one processor 310 may execute instructions or program codes of the second duty margin calculating module 304 to calculate the second duty margin using the second target duty ratio determined by the preset relational expression between the driving duty ratio and the driving current of the display 110 and the second reference duty ratio selected from among the plurality of calculated duty ratios.

Operation S400 of calculating the second duty margin will be described in greater detail below with reference to FIGS. 8A to 9B.

Referring to FIG. 5, in an embodiment, the operation method of the display device 100 may include operation S430 of determining a driving current corresponding to the second reference duty ratio by applying the second reference duty ratio to the preset relational expression between the driving duty ratio and the driving current. In an embodiment, the driving current may be a current that is applied to all the plurality of blocks of the display 110. In an embodiment, a driving current having the same magnitude may be provided to each of the plurality of blocks of the display 110. Accordingly, the driving current may be determined using the second reference duty ratio which is an average duty ratio of the plurality of duty ratios.

In an embodiment, the operation method of the display device 100 may include operation S500 of determining a correcting duty margin by comparing the first duty margin with the second duty margin.

According to an embodiment, in operation S500 of determining the correcting duty margin, the at least one processor 310 may execute instructions or program codes of the correcting duty margin calculating module 305 to determine the correcting duty margin by comparing the first duty margin with the second duty margin. The at least one processor 310 may compare the first duty margin with the second duty margin and determine a smaller duty margin of the two duty margins as the correcting duty margin. In a case where the two duty margins are the same duty margin, the same duty margin may be determined as the correcting duty margin.

In an embodiment, the operation method of the display device 100 may include operation S600 of driving the display 110 with a plurality of final duty ratios determined by the plurality of duty ratios and the correcting duty margin and a final driving current determined to correspond to the plurality of final duty ratios using a relational expression.

Referring to FIG. 5, in an embodiment, operation S600 of driving the display 110 with the plurality of final duty ratios and the final driving current may include operation S610 of calculating the plurality of final duty ratios using the correcting duty margin and the plurality of duty ratios. According to an embodiment, in operation S610 of calculating the plurality of final duty ratios, the plurality of final duty ratios may be calculated by adding the correcting duty margin to each of the plurality of duty ratios.

In an embodiment, operation S600 of driving the display 110 with the plurality of final driving duty ratios and the final driving current may include operation S620 of determining the final driving current using the correcting duty margin. According to an embodiment, in operation S620 of determining the final driving current, the final driving current may be determined by adding a current value corresponding to the correcting duty margin obtained by the relational expression to the driving current determined in operation S430 of determining the driving current.

However, the present disclosure is not limited thereto. According to an embodiment, in operation S620 of determining the final driving current, a final reference duty ratio may be determined based on the plurality of final duty ratios. In an embodiment, the final reference duty ratio may be an average duty ratio of the plurality of final duty ratios. In operation S620 of determining the final driving current, the final driving current may be determined by applying the final reference duty ratio to the relational expression.

In an embodiment, the final driving current may be a current that is provided to all the plurality of blocks of the display 110 which operates at the plurality of final duty ratios.

According to an embodiment, in operation S600 of driving the display 110 with the plurality of final duty ratios and the final driving current, the at least one processor 310 may control the display 110 with the plurality of final duty ratios and the final driving current to display an image 120.

According to an embodiment, in operation S610 of calculating the plurality of final duty ratios, the at least one processor 310 may execute instructions or program codes of the duty ratio calculating module 301 to calculate the plurality of final duty ratios by adding the correcting duty margin to each of the plurality of duty ratios.

According to an embodiment, in operation S620 of determining the final driving current, the at least one processor 310 may execute instructions or program codes of the driving current calculating module 302 to determine the final driving current by adding a current value corresponding to the correcting duty margin obtained using the relational expression to the driving current. The at least one processor 310 may determine the final driving current by applying the final driving current to the relational expression.

FIG. 6 is a flowchart illustrating an example operation of a display device for calculating a first duty margin according to various embodiments. Hereinafter, the same operations as those described with reference to FIGS. 4 and 5 are assigned like reference numerals and overlapping descriptions may not be repeated here.

Referring to FIGS. 3, 4, and 6, in an embodiment, operation S300 of calculating the first duty margin may include operation S310 of selecting a highest duty ratio among the plurality of calculated duty ratios as a first reference duty ratio. The operation method of the display device 100 may include operation S310 of selecting the highest duty ratio among the plurality of duty ratios as the first reference duty ratio, after operation S200 of calculating the plurality of duty ratios.

According to an embodiment, in operation S310 of selecting the first reference duty ratio, the at least one processor 310 may execute instructions or program codes of the duty ratio calculating module 301 to select the highest duty ratio among the plurality of calculated duty ratios as the first reference duty ratio.

However, the present disclosure is not limited thereto, and the operation method of the display device 100 may include operation of grouping a plurality of blocks divided from the display 110 into a plurality of block groups each having the same duty ratio, based on the plurality of calculated duty ratios, and selecting, as the second reference duty ratio, a highest duty ratio among a plurality of duty ratios corresponding to a plurality of block groups in each of which the number of one or more blocks is more than a preset threshold value, among the plurality of block groups. The preset threshold value may be a value set to prevent and/or reduce a duty ratio corresponding to image data that corresponds to abnormal data, noise, or a small region in an input image and does not affect image quality of an image 120 from being selected as the first reference duty ratio.

In an embodiment, operation S300 of calculating the first duty margin may include operation S320 of calculating the difference between the first target duty ratio and the first reference duty ratio as the first duty margin.

According to an embodiment, in operation S320 of calculating the first duty margin, the at least one processor 310 may execute instructions or program codes of the first duty margin calculating module 303 to calculate the difference between the first target duty ratio and the first reference duty ratio as the first duty margin. At this time, the first duty margin may also be a ratio.

FIG. 6 shows operation S310 of selecting the first reference duty ratio and operation S320 of calculating the first duty margin separately. However, the present disclosure is not limited thereto. In an embodiment, an operation of selecting the first duty ratio and an operation of calculating the first duty margin may be performed in one operation.

FIG. 7A is a diagram illustrating an example operation of a display device for calculating a first duty margin according to various embodiments.

Referring to FIGS. 1, 3, and 7A, in an embodiment, the display 110 that is divided into a plurality of blocks 700 and driven, and an image 120 displayed on the display 110 are shown in FIG. 7A.

In an embodiment, the display device 100 may control the display 110 to display the image 120 by driving the plurality of blocks 700 at driving duty ratios corresponding to the respective blocks. The display device 100 may control the display 110 to display the image 120 by providing a driving current to all the plurality of blocks.

In an embodiment, in a case where the display 110 includes a backlight, the plurality of blocks 700 may be unit components for which the backlight operates. The backlight may be divided into the plurality of blocks 700 and driven, and the plurality of blocks 700 may be driven at respective driving duty ratios. At this time, a driving current may be provided to all the plurality of blocks 700. Hereinafter, for convenience of description, a case where the display 110 is divided into the plurality of blocks 700 and operates will be described. However, in a case where the display 110 includes a backlight, the backlight may be divided into the plurality of blocks 700 and operate.

In an embodiment, the at least one processor 310 may analyze an input image to calculate a plurality of duty ratios 710 at which the plurality of blocks 700 are respectively driven. In an embodiment, the at least one processor 310 may calculate a duty ratio of a block corresponding to a region having a high gradation in the input image as a higher duty ratio than a duty ratio of a block corresponding to a region having a low gradation in the input image. However, the present disclosure is not limited thereto, and the at least one processor 310 may calculate the plurality of duty ratios 710 at which the plurality of blocks 700 are respectively driven by considering a movement of an object included in the input image, distinction between the object and a background, a contrast ratio with respect to surrounding regions, sharpness of the input image, etc.

In an embodiment, referring to FIG. 7A, in a case where the plurality of blocks 700 include a first block 701 and a second block 702, an input image corresponding to the first block 701 may include a 'human face'. An input image corresponding to the second block 702 may include a 'logo' or 'subtitle', etc.

In an embodiment, the plurality of duty ratios 710 may include a first duty ratio 711 corresponding to the first block 701 and a second duty ratio 712 corresponding to the second block 702. In this case, the first duty ratio 711 may correspond not only to the first block 701, but also to at least another block calculated to be driven at the first duty ratio 711 among the plurality of blocks 700 based on the input image. The display device 100 may drive not only the first block 701, but also the at least another block at the first duty ratio 711.

In an embodiment, the first duty ratio 711 may be different from the second duty ratio 712. In a case where a gradation of an input image corresponding to the second block 702 is higher than a gradation of an input image corresponding to the first block 701, the second duty ratio 712 may be higher than the first duty ratio 711.

However, the present disclosure is not limited thereto, and in a case where a duty ratio of a block corresponding to a 'logo' or 'subtitle' part is set in advance to be calculated as a higher duty ratio than a duty ratio of a block corresponding to the remaining part of the image, the second duty ratio 712 may be higher than the first duty ratio 711 regardless of a gradation of an input image.

Also, in a case where a duty ratio of a block corresponding to an object such as a 'person' is set in advance to be calculated as a higher duty ratio than a duty ratio of a block corresponding to the remaining part of the image such as a 'background', the first duty ratio 711 may be higher than the second duty ratio 712. For example, the plurality of duty ratios 710 corresponding to the plurality of blocks 700 may be calculated as different values based on an input image.

In an embodiment, a preset first target duty ratio 720 is shown in FIG. 7A. In an embodiment, the first target duty ratio 720 may be a highest duty ratio at which the display 110 is capable of being driven within one frame 131. In an embodiment, a length of one frame 131 may be determined depending on a driving frequency of the display 110. The first target duty ratio 720 may be a ratio of a longest turn-on period for which an image is capable of being displayed on the display 110 to one frame 131 having a determined length.

In an embodiment, a first reference duty ratio 712 may be a highest duty ratio among the plurality of duty ratios 710. In FIG. 7A, the second duty ratio 712 is shown as the first reference duty ratio 712.

In an embodiment, a first duty margin 730 may be a difference between the first target duty ratio 720 and the first reference duty ratio 712. In an embodiment, in a case where an input image is capable of having a gray scale ranging from 0 to 255, the first target duty ratio 720 may be a duty ratio at which the display 110 is driven to display an image 120 corresponding to an input image including a gray scale of 255. The first reference duty ratio 712 may be a duty ratio at which the display 110 is driven to display an image 120 corresponding to a highest gray scale among gray scales included in an input image.

In an embodiment, a first duty margin 730 when a highest gray scale among gray scales included in an input image is a gray scale of 200 may be less than a first duty margin 730 when a highest gray scale among gray scales included in an input image is a gray scale of 150.

FIG. 7B is a diagram illustrating an example operation of a display device for calculating a first duty margin according to a region of interest and a region of non-interest according to various embodiments. Hereinafter, the same components as those described with reference to FIG. 7A are assigned like reference numerals and overlapping descriptions may not be repeated here.

Referring to FIGS. 1, 3, 7A, and 7B, in an embodiment, the display 110 that is divided into a plurality of blocks 700 and driven and an image 120 displayed on the display 110 are shown in FIG. 7B.

According to an embodiment, referring to FIG. 7B, the plurality of blocks 700 may include a first block 701, a second block 702, and a third block 703. In an embodiment, an input image corresponding to the third block 703 may include a 'background'.

In an embodiment, a plurality of duty ratios 710 may include a first duty ratio 711 corresponding to the first block 701, a second duty ratio 712 corresponding to the second block 702, and a third duty ratio 713 corresponding to the third block 703.

In an embodiment, a gradation of an input image corresponding to the third block 703 may be higher than a gradation of an input image corresponding to the first block 701 and a gradation of an input image corresponding to the second block 702. Accordingly, the third duty ratio 713 may be higher than the first duty ratio 711 and the second duty ratio 712.

In an embodiment, a preset threshold value 740 is shown in FIG. 7B. The threshold value 740 may be a preset value to, when the number of blocks having a specific duty ratio is less than the threshold value, prevent and/or reduce the duty ratio corresponding to the corresponding blocks from being selected as a first reference duty ratio. In an embodiment, because the number of blocks having the third duty ratio 713 is less than the threshold value although the third duty ratio 713 is higher than the second duty ratio 712, the third duty ratio 712 instead of the third duty ratio 713 may be selected as a first reference duty ratio. The at least one processor 310 may determine the second duty ratio 712 instead of the third duty ratio 713 as the first reference duty ratio.

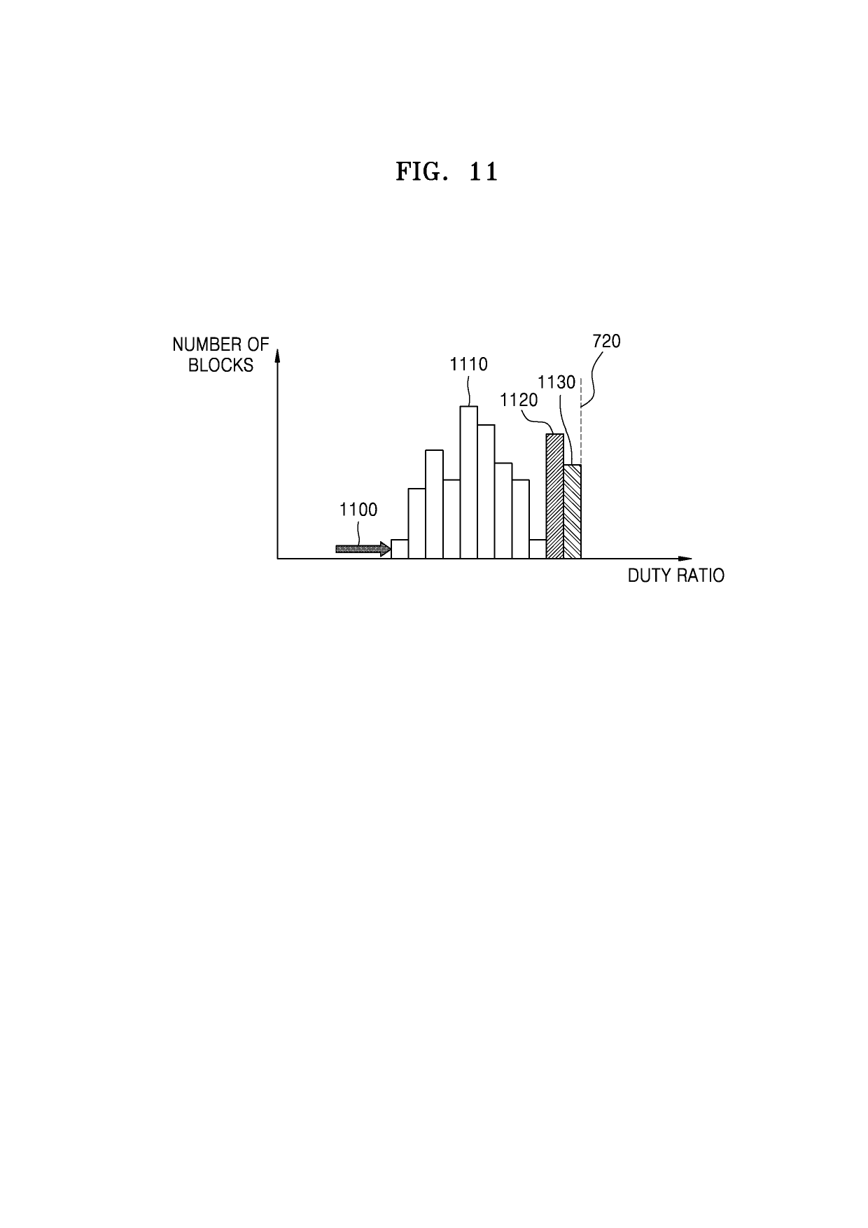

A case where the number of blocks having a specific duty ratio is equal to or more than the threshold value may be a case where a region of the display 110 driven at the specific duty ratio is equal to or larger than a preset area. Accordingly, a situation in which a specific duty ratio driven in a smaller region than a preset area of the display 110 is determined as a first reference duty ratio may be prevented/reduced. Therefore, a situation in which a correcting duty margin 1100 (see FIG. 11) which will be described below is calculated as a low duty margin due to a specific duty ratio of a region that occupies a small area in an image 120 and thus is little interested by users may be prevented/reduced.

FIG. 7B shows a case where the display 110 is divided into a region of interest 750 and a region of non-interest 760 based on an input image. In an embodiment, the region of interest 750 may be a region in which a user is expected to have a relatively high interest in an image 120 displayed on the display 110. The region of non-interest 760 may be a region in which a user is expected to have a relatively low interest in the image 120 displayed on the display 110.

In an embodiment, the region of interest 750 may be a region in which an image including an 'object (for example, a person, an animal, an object, etc.)' is determined to be displayed on the display 110 based on input images. The region of non-interest 760 may be a region in which an image including a 'background' is determined to be displayed on the display 110 based on the input images.

However, the present disclosure is not limited thereto, and a condition for distinguishing between the region of interest 750 and the region of non-interest 760 may be set in advance, and the at least one processor 310 may analyze an input image according to the set condition to divide the display 110 into the region of interest 750 and the region of non-interest 760.

In an embodiment, when the at least one processor 310 compares the number of blocks having a specific duty ratio to the threshold value, the at least one processor 310 may assign different weights to the blocks according to whether the blocks are located in the region of interest 750 or the region of non-interest 760. In an embodiment, when the at least one processor 310 compares the number of blocks included in the region of interest 750 the at least one processor 310 may multiply the number of the blocks by a weight that is equal to or greater than 1. when the at least one processor 310 compares the number of blocks included in the region of non-interest 760, the at least one processor 310 may multiply the number of the blocks by a weight that is smaller than 1.

Therefore, when the number of blocks located in the region of interest 750 and having a specific duty ratio is compared to the threshold value 740, the number of the blocks may be determined to be equal to or more than the threshold value 740 although the number of the blocks is less than the threshold value 740, and the blocks may be considered in selecting a first reference duty ratio. When the number of blocks located in the region of non-interest 760 and having a specific duty ratio is compared to the threshold value 740, the number of the blocks may be determined to be less than the threshold value 740 although the number of the blocks is more than the threshold value 740, and the blocks may not be considered in selecting a first reference duty ratio.

Therefore, when a plurality of final duty margins are calculated using a correcting duty margin 110 determined by comparing a first duty margin 730 and a second duty margin 970 (see FIG. 9A) which will be described below, final duty margins of blocks located in the region of interest 750 may be prevented /reduced from exceeding the first target duty ratio 720. A situation in which the correcting duty margin 110 is calculated to be unnecessarily small due to duty ratios of blocks located in the region of non-interest 760 in which a user has a low interest may be prevented/reduced.

FIG. 7C is a flowchart illustrating an example operation of a display device for calculating a first duty margin according to motion of an input image according to various embodiments. Hereinafter, the same operations as those described with reference to FIGS. 4 and 5 are assigned like reference numerals, and overlapping descriptions may not be repeated here.

Referring to FIGS. 3, 4, 5, and 7C, in an embodiment, the operation method of the display device 100 may include operation S210 of analyzing a motion of an obtained input image based on the input image. Here, 'motion' may refer, for example, to a movement of an object included in an input image, a change of the object, a movement speed of a background, etc.

In an embodiment, the at least one processor 310 may analyze the motion of the input image by analyzing the input image. In an embodiment, as the motion of the input image increases, the at least one processor 310 may set the first target duty ratio 720 to be lower.

Accordingly, as a motion of an input image increases, the first duty margin calculated in operation S300 of calculating the first duty margin may become smaller. Therefore, when a motion of an input image is large, a correcting duty margin which will be described below may be calculated as a small value so as not to affect Frame Rate Control (FRC) for displaying an image with a large motion.

FIG. 8A is a flowchart illustrating an example operation of a display device for calculating a second duty margin according to various embodiments. Hereinafter, the same operations as those described with reference to FIGS. 4 and 5 are assigned like reference numerals, and overlapping descriptions may not be repeated here.

Referring to FIGS. 3, 4, 5, and 8A, in an embodiment, operation S400 of calculating the second duty margin may include operation S410 of determining (or select) an average duty ratio of the plurality of calculated duty ratios as the second reference duty ratio.

In an embodiment, in FIG. 8A, operation S410 of determining the average duty ratio of the plurality of duty ratios as the second reference duty ratio is shown as being performed after operation S300 of calculating the first duty margin. However, the present disclosure is not limited thereto. Operation S410 of determining the average duty ratio of the plurality of calculated duty ratios as the second reference duty ratio may be performed after operation S200 of calculating the duty ratios of the plurality of blocks.

According to an embodiment, in operation S410 of determining the average duty ratio of the plurality of duty ratios as the second reference duty ratio, the at least one processor 310 may execute instructions or program codes of the second duty margin calculating module 304 to determine the average duty ratio of the plurality of duty ratios as the second reference duty ratio. The second reference duty ratio may be a duty ratio used to determine a driving current of the display 110, which will be described below. In this case, because the driving current is provided to all the plurality of blocks of the display 110, the second reference duty ratio may be determined as an average duty ratio of a plurality of duty ratios respectively corresponding to the plurality of blocks.

In an embodiment, operation S400 of calculating the second duty margin may include operation S420 of calculating the difference between a second target duty ratio and the second reference duty ratio as the second duty margin. Hereinafter, operation S420 of calculating the second duty margin will be described in greater detail below with reference to FIGS. 9A and 9B.

FIG. 8B is a flowchart illustrating an example operation of a display device for calculating a second duty margin according to a mode selection input of selecting a first mode or a second mode according to various embodiments. Hereinafter, the same operations as those described with reference to FIGS. 4, 5, and 8A are assigned like reference numerals, and overlapping descriptions may not be repeated here.

Referring to FIGS. 3, 4, 8A, and 8B, the operation method of the display device 100 may include operation S421 of obtaining a mode selection input of selecting a first mode in which luminance of the display 110 is maintained constant or a second mode in which power consumption of the display 110 is maintained constant. In an embodiment, luminance of the display 110 may refer, for example, to luminance of an image displayed on the display 110.

According to an embodiment, in FIG. 8B, operation S421 of obtaining the mode selection input is shown as being performed after operation S420 of selecting the average duty ratio of the plurality of duty ratios as the second reference duty ratio. However, an operation sequence of operation S421 of obtaining the mode selection input is not limited thereto.

According to an embodiment, in operation S421 of obtaining the mode selection input, the at least one processor 310 may obtain a user input of selecting any mode of the first mode or the second mode through the user interface.

However, the present disclosure is not limited thereto. Whether the display device 100 operates in the first mode or the second mode may have been set in advance. In this case, although an operation of obtaining a mode selection input is not performed, the display device 100 may operate in a selected mode.

In an embodiment, the operation method of the display device 100 may include operation S422 of, according to the first mode being selected based on the obtained mode selection input, calculating a second duty margin using a second target duty ratio determined by a first relational expression and the second reference duty ratio. In this case, the first relational expression may be a relational expression set to change a driving current of the display 110 according to a change in driving duty ratio of the display 110 in order to maintain a constant luminance of the display 110.

In an embodiment, according to the first mode being selected based on the obtained mode selection input, the at least one processor 310 may calculate the second duty margin using the second target duty ratio determined by the first relational expression and the second reference duty ratio. Hereinafter, the first relational expression and an operation of calculating the second duty margin using the first relational expression will be described in greater detail with reference to FIG. 9A.

In an embodiment, the operation method of the display device 100 may include operation S423 of, according to the second mode being selected based on the obtained mode selection input, calculating the second duty margin using a second target duty ratio determined by a second relational expression and the second reference duty ratio. In this case, the second relational expression may be a relational expression set to change a driving current of the display 110 according to a change in driving duty ratio of the display 110 in order to maintain constant power consumption of the display 110.

In an embodiment, according to the second mode being selected based on the obtained mode selection input, the at least one processor 310 may calculate the second duty margin using the second target duty ratio determined by the second relational expression and the second reference duty ratio. Hereinafter, the second relational expression and an operation of calculating the second duty margin using the second relational expression will be described in greater detail with reference to FIG. 9B.

FIG. 9A is a graph illustrating an example operation of a display device for calculating a second duty margin using a first relational expression used in a first mode and a second target duty ratio determined by the first relational expression according to various embodiments.

Referring to FIGS. 2, 3, and 9A, in an embodiment, FIG. 9A shows a graph 900 representing the first relational expression used in the first mode in which luminance of the display 110 is maintained constant. Hereinafter, the graph 900 representing the first relational expression is referred to as a first mode graph 900, and the first relational expression will be described using the first mode graph 900.

In an embodiment, an x-axis of the first mode graph 900 may be a second reference duty ratio. In an embodiment, the x-axis of the first mode graph 900 may be an average duty ratio of a plurality of duty ratios. In an embodiment, an y-axis of the first mode graph 900 may be a driving current of the display 110. In an embodiment, the first mode graph 900 may represent a driving current for maintaining luminance of the display 110 constant as the second reference duty ratio of the display 110 changes.

In an embodiment, the first mode graph 900 may include a first saturation current 910 and a second saturation current 920. In an embodiment, the first saturation current 910 may be a minimum driving current required to drive the display 110. In an embodiment, when a current that is less than the first saturation current 910 is provided to the display 110, the display 110 may not operate normally.

In an embodiment, the second saturation current 920 may refer, for example, to a maximum driving current capable of driving the display 110. In an embodiment, when a current that is larger than the second saturation current 920 is provided to the display 110, the display 110 may not operate normally due to overload or the like.

In an embodiment, a duty ratio corresponding to the first saturation current 910 may be a first saturation duty ratio 940. A duty ratio corresponding to the second saturation current 920 may be a second saturation duty ratio 950. In this case, luminance of the display 110 driven with the first saturation current 910 and the first saturation duty ratio 940 may be substantially the same as luminance of the display 110 driven with the second saturation current 920 and the second saturation duty ratio 950.

In an embodiment, when luminance of the display 110 is constant, the higher a duty ratio and the smaller a magnitude of a driving current, the lower power consumption. Therefore, power consumption of the display 110 driven with the first saturation current 910 and the first saturation duty ratio 940 may be lower than power consumption of the display 110 driven with the second saturation current 920 and the second saturation duty ratio 950.

In an embodiment, a driving current 930 corresponding to a second reference duty ratio 960 may be determined by the first mode graph 900. In an embodiment, luminance of the display 110 driven with the second reference duty ratio 960 and the driving current 930 may be equal to luminance of the display 110 driven with the second saturation current 920 and the second saturation duty ratio 950.

In an embodiment, power consumption of the display 110 driven with the second reference duty ratio 960 and the driving current 930 corresponding to the second reference duty ratio 960 may be lower than power consumption of a display 110 driven with the second saturation current 920 and the second saturation duty ratio 950.

In an embodiment, the at least one processor 310 may determine the first saturation duty ratio 940 as the second target duty ratio 940. The at least one processor 310 may determine a difference between the second target duty ratio 940 and the second reference duty ratio 960 as a second duty margin 970.

In an embodiment, the second duty margin 970 may be a difference between a duty ratio when the display 110 operates with the minimum driving current 910 and the second reference duty ratio 960 determined by the display 110 based on an input image.

FIG. 9B is a graph illustrating an example operation of a display device for calculating a second duty margin using a second relational expression used in a second mode and a second target duty ratio determined by the second relational expression according to various embodiments.

Referring to FIGS. 2, 3, 9A, and 9B, according to an embodiment, a graph 901 representing a second relational expression used in the second mode in which power consumption of the display 110 is maintained constant is shown in FIG. 9B. Hereinafter, the graph 901 representing the second graph is referred to as a second mode graph 901, and the second relational expression will be described using the second mode graph 901.

In an embodiment, an x-axis of the second mode graph 901 may be a second reference duty ratio. In an embodiment, the x-axis of the second mode graph 901 may be an average duty ratio of a plurality of duty ratios. In an embodiment, a y-axis of the second mode graph 901 may be a driving current of the display 110. In an embodiment, the second mode graph 901 may represent a driving current for maintaining power consumption of the display 110 constant while the second reference duty ratio of the display 110 changes.

In an embodiment, the second mode graph 901 may include a first saturation current 910 and a second saturation current 920. In an embodiment, the first saturation current 910 may refer, for example, to a minimum driving current required to drive the display 110. In an embodiment, the second saturation current 920 may refer, for example, to a maximum driving current capable of driving the display 110.

In an embodiment, a duty ratio corresponding to the first saturation current 910 may be a third saturation duty ratio 941. A duty ratio corresponding to the second saturation current 920 may be a fourth saturation duty ratio 951. In this case, power consumption of the display 110 driven with the first saturation current 910 and the third saturation duty ratio 941 may be the equal to power consumption of the display 110 driven with the second saturation current 920 and the fourth saturation duty ratio 951.

In an embodiment, when power consumption of the display 110 is constant, the higher a duty ratio and the smaller a magnitude of a driving current, the higher luminance of the display 110. Therefore, luminance of the display 110 driven with the first saturation current 910 and the third saturation duty ratio 941 may be higher than luminance of the display 110 driven with the second saturation current 920 and the fourth saturation duty ratio 951.

In an embodiment, a driving current 931 corresponding to the second reference duty ratio 960 may be determined by the second mode graph 901. In an embodiment, power consumption of the display 110 driven with the second reference duty ratio 960 and the driving current 931 may be equal to power consumption of the display 110 driven with the second saturation current 920 and the fourth saturation duty ratio 951.

In an embodiment, luminance of the display 110 driven with the second reference duty ratio 960 and the driving current 931 corresponding to the second reference duty ratio 960 may be higher than luminance of the display 110 driven with the second saturation current 920 and the fourth saturation duty ratio 951.

In an embodiment, the at least one processor 310 may determine the third saturation duty ratio 941 as a second target duty ratio 941. The at least one processor 310 may determine a difference between the second target duty ratio 941 and the second reference duty ratio 960 as a second duty margin 971.

In an embodiment, the first saturation current 910 and the second saturation current 920 included in the first mode graph 900 may be respectively equal to the first saturation current 910 and the second saturation current 920 included in the second mode graph 901. The first saturation current 910 and the second saturation current 920 may be determined by specifications of the display 110, regardless of an operation mode of the display device 100.

In an embodiment, in a case where the second saturation duty ratio 950 of the first mode graph 900 and the fourth saturation duty ratio 951 of the second mode graph 901 are set to be the same, the third saturation duty ratio 941 of the second mode graph 901 may be higher than the first saturation duty ratio 940 of the first mode graph 900. Accordingly, the second duty margin 971 in the second mode graph 901 may be greater than the second duty margin 970 in the first mode graph 900. A calculated magnitude of a second duty margin may vary depending on an operation mode of the display device 100.

FIG. 10 is a flowchart illustrating an example operation of a display device for determining a correcting duty margin according to various embodiments. Hereinafter, the same operations as those described with reference to FIGS. 4 and 5 are assigned like reference numerals, and overlapping descriptions may not be repeated here.

Referring to FIGS. 3, 4, 5 and 10, in an embodiment, operation S500 of determining the correcting duty margin may include operation S510 of comparing the first duty margin 730 (see FIG. 7A) with the second duty margin 970 or 971 (see FIGS. 9A and 9B) to determine whether the second duty margin 970 or 971 is less than the first duty margin 730.

In an embodiment, in operation S510 of determining whether the second duty margin 970 or 971 is less than the first duty margin 730, the second duty margin 970 or 971 may be determined to be less than the first duty margin 730. In this case, in operation S500 of determining the correcting duty margin, the second duty margin 970 or 971 may be determined as the correcting duty margin (S520).

In an embodiment, in operation S510 of determining whether the second duty margin 970 or 971 is less than the first duty margin 730, the first duty margin 730 may be determined to be less than or equal to the second duty margin 970 or 971. In this case, in operation S500 of determining the correcting duty margin, the first duty margin 730 may be determined as the correcting duty margin (S530).

In this case, the second duty margin 970 or 971 may be a duty margin determined using the first relational expression 900 or the second relational expression 901 when the display device 100 operates in any of the first mode or the second mode.

In an embodiment, in operation S600 of driving the display with the plurality of final duty ratios determined using the correcting duty margin and the final driving current determined to correspond to the plurality of final duty ratios, the first duty margin 730 or the second duty margin 970 may be used as the correcting duty margin depending on a comparison result between the first duty margin 730 and the second duty margin 970.

FIG. 11 is a graph illustrating a plurality of final duty ratios determined using a correcting duty margin according to various embodiments.

Referring to FIGS. 1, 3, 5, 7A, and 11, in an embodiment, a correcting duty margin 1100 and a plurality of final duty ratios 1110 determined using the correcting duty margin 1100 are shown in FIG. 11.

In an embodiment, compared to FIG. 7A, each of the plurality of final duty ratios 1110 shown in FIG. 11 may be a duty ratio obtained by adding the correcting duty margin 1100 to each of the plurality of duty ratios 710. In an embodiment, the plurality of final duty ratios 1110 may be duty ratios calculated by Pulse Width Modulation (PWM) technology using the plurality of duty ratios 710 and the correcting duty margin 1100.

In an embodiment, a first final duty ratio 1120 obtained by adding the correcting duty margin 1100 to the first duty ratio 711 of FIG. 7A and a second final duty ratio 1130 obtained by adding the correcting duty margin 1100 to the second duty ratio 712 are shown in FIG. 11.

In an embodiment, when the first duty margin 730 is determined to be equal to or less than the second duty margin 970 or 971 and thus the first duty margin 730 is determined as the correcting duty margin 1100, the second final duty ratio 1130 may be equal to the first target duty ratio 720. However, the present disclosure is not limited thereto. When the second duty margin 970 or 971 is determined to be less than the first duty margin 730 and thus the second duty margin 970 or 971 is determined as the correcting duty margin 1100, the second final duty ratio 1130 may be lower than the first target duty ratio 720.

In an embodiment, because the correcting duty margin 1100 is not greater than the first duty margin 730, each of the plurality of final duty ratios 1110 may be equal to or less than the first target duty ratio 720. Accordingly, when the plurality of blocks 700 included in the display 110 are driven at the plurality of final duty ratios 1110 to display an image 120, image quality of the image 120 may be prevented/reduced from deteriorating. Also, by displaying an image 120 on the display 110 using technology such as local dimming, image quality of the image 120 may be improved.

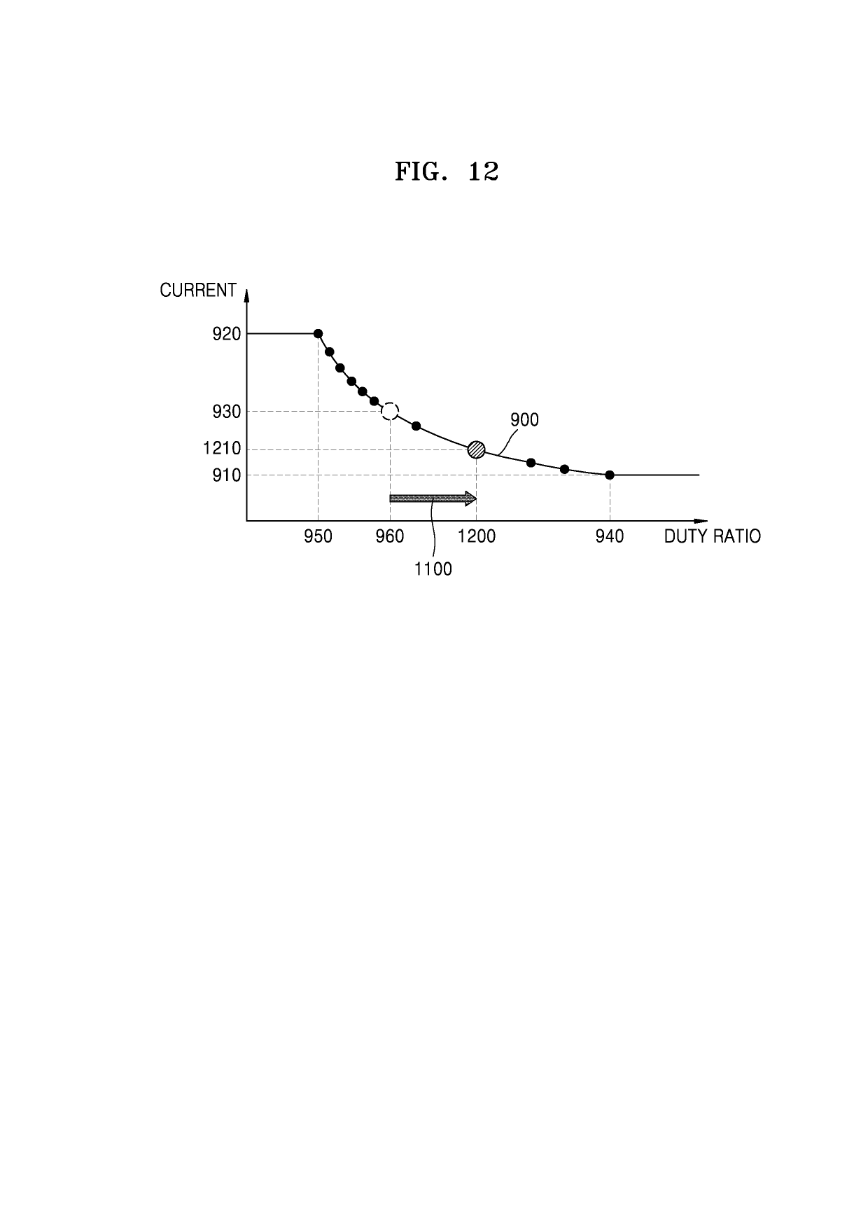

FIG. 12 is a graph illustrating a final driving current determined using a correcting duty margin according to various embodiments. Hereinafter, the same components as those described with reference to FIG. 9A are assigned like reference numerals, and overlapping descriptions may not be repeated here.

Referring to FIGS. 1, 3, 5, 9A, 11, and 12, in an embodiment, the first mode graph 900, the second reference duty ratio 960, the driving current 930 corresponding to the second reference duty ratio 960, the correcting duty margin 1100, a final reference duty ratio 1200 determined by the plurality of final duty ratios 1110, and a final driving current 1210 corresponding to the final reference duty ratio 1200 are shown in FIG. 12.

In an embodiment, the final reference duty ratio 1200 may be an average duty ratio of the plurality of final duty ratios 1110. The at least one processor 310 may determine the final reference duty ratio 1200 by calculating the average duty ratio of the plurality of final duty ratios 1110. The final reference duty ratio 1200 may be higher than the second reference duty ratio 960.

In an embodiment, the final driving current 1210 may be a current calculated using the correcting duty margin 1100, compared to the driving current 930. The final driving current 1210 may be a current calculated by Pulse Amplitude Modulation (PAM) technology using the driving current 930 and the correcting duty margin 1100. The final driving current 1210 may be less than the driving current 930.

In an embodiment, when the first duty margin 730 is determined to be equal to or less than the second duty margin 970 or 971 and thus the first duty margin 730 is determined as the correcting duty margin 1100, the final reference duty ratio 1200 may be equal to or lower than the second target duty ratio 940. However, the present disclosure is not limited thereto. When the second duty margin 970 or 971 is determined to be less than the first duty margin 730 and thus the second duty margin 970 or 971 is determined as the correcting duty margin 1100, the final reference duty ratio 1200 may be equal to the second target duty ratio 940.

In an embodiment, because the correcting duty margin 1100 is not greater than the second duty margin 970, the final reference duty ratio 1200 may be equal to or lower than the second target duty ratio. Accordingly, the final driving current 1210 corresponding to the final reference duty ratio 1200 may be equal to or larger than the first saturation current 910.

Accordingly, when the display device 100 drives the display 110 with the plurality of final duty ratios and the final driving current, the display device 100 may display an image 120 having the same luminance on the display 110 with lower power consumption than when the display device 100 drives the display 110 with the plurality of duty ratios and the driving current corresponding to the second reference duty ratio 960. Also, by providing a driving current that is less than the minimum driving current for driving the display 110 to the display 110, the display 110 may be prevented/reduced from being wrongly driven.

In an embodiment, the final reference duty ratio 1200 and the final driving current 1210 calculated using the first mode graph 900 of when the display device 100 operates in the first mode are shown in FIG. 12. However, the present disclosure is not limited thereto. When the display device 100 operates in the second mode, a final reference duty ratio and a final driving current may be calculated using the second mode graph 901.

The final reference duty ratio calculated using the second mode graph 901 may be equal to the final reference duty ratio calculated by using the first mode graph 900. The final reference duty ratio calculated using the second mode graph 901 may be higher than the final driving current calculated using the first mode graph 900.

In this case, when the display device 100 drives the display 110 with the plurality of final duty ratios and the final driving current, the display device 100 may display an image 120 having a higher luminance on the display 110 with the same power consumption as when the display device 100 drives the display 110 with the plurality of duty ratios and the driving current corresponding to the second reference duty ratio 960. Also, by providing the display 110 with a driving current that is less than the minimum driving current for driving the display 110, the display 110 may be prevented/reduced from being wrongly driven.

Effects that may be achieved by the present disclosure are not limited to the above-mentioned effects, and other effects not mentioned will be clearly understood by one of ordinary skill in the technical field to which the present disclosure belongs from the present disclosure.

To address the above-described technical problems, in an example embodiment of the present disclosure, a display device is provided. The display device may include a display divided into a plurality of blocks and being driven. The display device may include memory storing at least one instruction. The display device may include at least one processor configured to execute the at least one instruction stored in the memory. The at least one processor may be configured to execute the at least one instruction to cause the display device to obtain an input image. The at least one processor may be configured to execute the at least one instruction to cause the display device to calculate a plurality of duty ratios at which the plurality of blocks are respectively driven within one frame, based on the obtained input image. The at least one processor may be configured to execute the at least one instruction to cause the display device to calculate a first duty margin using a preset first target duty ratio and a first reference duty ratio selected from among the plurality of calculated duty ratios. The at least one processor may be configured to execute the at least one instruction to cause the display device to calculate a second duty margin using a second target duty ratio determined by a preset relational expression between a driving current and a driving duty ratio of the display and a second reference duty ratio determined based on the plurality of calculated duty ratios. The at least one processor may be configured to execute the at least one instruction to cause the display device to determine a correcting duty margin by comparing the first duty margin with the second duty margin. The at least one processor may be configured to execute the at least one instruction to cause the display device to drive the display with a plurality of final duty ratios determined using the plurality of duty ratios and the correcting duty margin, and a final driving current determined to correspond to the plurality of final duty ratios using the relational expression.

In an example embodiment of the present disclosure, the at least one processor may be configured to execute the at least one instruction to cause the display device to select a highest duty ratio among the plurality of calculated duty ratios as the first reference duty ratio.

In an example embodiment of the present disclosure, the first target duty ratio may be a ratio set to a highest duty ratio at which the display 110 is capable of being driven within the one frame.

In an example embodiment of the present disclosure, the at least one processor may be configured to execute the at least one instruction to cause the display device to calculate a difference between the first target duty ratio and the first reference duty ratio as the first duty margin.

In an example embodiment of the present disclosure, the at least one processor may be configured to execute the at least one instruction to cause the display device to determine an average duty ratio of the plurality of calculated duty ratios as the second reference duty ratio.

In an example embodiment of the present disclosure, the relational expression may include a minimum driving current for driving the display 110 and a minimum driving duty ratio corresponding to the minimum driving current. The at least one processor may be configured to execute the at least one instruction to cause the display device to determine the minimum driving duty ratio as the second target duty ratio.

In an example embodiment of the present disclosure, the at least one processor may be configured to execute the at least one instruction to cause the display device to calculate a difference between the second target duty ratio and the second reference duty ratio as the second duty margin.

In an example embodiment of the present disclosure, the at least one processor may be configured to execute the at least one instruction to cause the display device to compare the first duty margin with the second duty margin and determine the first duty margin as the correcting duty margin according to the first duty margin being equal to or less than the second duty margin. The at least one processor may be configured to execute the at least one instruction to cause the display device to determine the second duty margin as the correcting duty margin according to the second duty margin being less than the first duty margin.

In an example embodiment of the present disclosure, the relational expression may include a first relational expression representing a relationship between the driving duty ratio and the driving current to maintain a constant luminance of the display and a second relational expression representing a relationship between the driving duty ratio and the driving current to maintain constant power consumption of the display. The at least one processor may be configured to execute the at least one instruction to cause the display device to obtain a mode selection input of selecting a first mode in which luminance of the display is maintained constant or a second mode in which power consumption of the display is maintained constant. The at least one processor may be configured to execute the at least one instruction to cause the display device to, based on the obtained mode selection input, calculate the second duty margin using the second target duty ratio determined by the first relational expression and the second reference duty ratio when the first mode is selected. The at least one processor may be configured to execute the at least one instruction to cause the display device to, based on the obtained mode selection input, calculate the second duty margin using the second target duty ratio determined by the second relational expression and the second reference duty ratio when the second mode is selected.

In an example embodiment of the present disclosure, the at least one processor may be configured to execute the at least one instruction to cause the display device to drive the plurality of blocks of the display at the plurality of final duty ratios respectively corresponding to the plurality of blocks. The at least one processor may be configured to execute the at least one instruction to cause the display device to drive the display with the final driving current.

To address the above-described technical problems, an example embodiment of the present disclosure provides an operation method of a display device. The operation method of the display device may include obtaining an input image. The operation method of the display device may include calculating a plurality of duty ratios at which a plurality of blocks of the display, divided within one frame, are respectively driven, based on the obtained input image. The operation method of the display device may include calculating a first duty margin using a preset first target duty ratio and a first reference duty ratio selected from among the plurality of calculated duty ratios. The operation method of the display device may include calculating a second duty margin using a second target duty ratio determined by a preset relational expression between a driving duty ratio and a driving current of the display and a second reference duty ratio determined based on the plurality of calculated duty ratios. The operation method of the display device may include determining a correcting duty margin by comparing the first duty margin with the second duty margin. The operation method of the display device may include driving the display with a plurality of final duty ratios determined using the plurality of duty ratios and the correcting duty margin and a final driving current determined to correspond to the plurality of final duty ratios using the relational expression.

In an example embodiment of the present disclosure, the calculating of the first duty margin may include selecting a highest duty ratio among the plurality of calculated duty ratios as the first reference duty ratio.

In an example embodiment of the present disclosure, the calculating of the first duty margin may include calculating a difference between the first target duty ratio and the first reference duty ratio as the first duty margin.

In an example embodiment of the present disclosure, the calculating of the first duty margin may include determining an average duty ratio of the plurality of calculated duty ratios as the second reference duty ratio.

In an example embodiment of the present disclosure, the relational expression may include a minimum driving current for driving the display 110 and a minimum driving duty ratio corresponding to the minimum driving current. The second target duty ratio may be a duty ratio set to the minimum driving duty ratio.

In an example embodiment of the present disclosure, the calculating of the second duty margin may include calculating a difference between the second target duty ratio and the second reference duty ratio as the second duty margin.

In an example embodiment of the present disclosure, the determining of the correcting duty margin may include comparing the first duty margin with the second duty margin and determining the first duty margin as the correcting duty margin according to the first duty margin being equal to or less than the second duty margin. The determining of the correcting duty margin may include determining the second duty margin as the correcting duty margin according to the second duty margin being less than the first duty margin.

In an example embodiment of the present disclosure, the relational expression may include a first relational expression representing a relationship between the driving duty ratio and the driving current to maintain a constant luminance of the display and a second relational expression representing a relationship between the driving duty ratio and the driving current to maintain constant power consumption of the display. The operation method of the display device may include obtaining a mode selection input of selecting a first mode in which luminance of the display is maintained constant or a second mode in which power consumption of the display is maintained constant. According to the first mode being selected in the obtaining of the mode selection input, the calculating of the second duty margin may include calculating the second duty margin using the second target duty ratio determined by the first relational expression and the second reference duty ratio. According to the second mode being selected in the obtaining of the mode selection input, the calculating of the second duty margin may include calculating the second duty margin using the second target duty ratio determined by the second relational expression and the second reference duty ratio.

To address the above-described technical problems, in an example embodiment, a non-transitory computer-readable recording medium having recorded thereon a program for performing at least one method among the disclosed embodiments of the operation method of the display device on a computer may be provided.

A program that is executed by the electronic device described in the present disclosure may be implemented by a hardware component, a software component, and/or a combination of a hardware component and a software component. The program may be performed by all systems capable of executing computer-readable instructions.

The software may include a computer program, code, instructions, or a combination of one or more of these, and may configure a processing device or independently or collectively instruct a processing device to perform a desired operation.

The software may be implemented as a computer program including instructions stored in computer-readable storage media. The computer-readable recording media may include, for example, a magnetic storage medium (for example, read-only memory (ROM), random-access memory (RAM), a floppy disc, a hard disc, etc.) and an optical readable medium (for example, compact disc-read only memory (CD-ROM), Digital Versatile Disc (DVD), etc.) The computer-readable recording media may be distributed to computer systems over a network, in which computer-readable codes may be stored and executed in a distributed manner. The recording medium may be readable by a computer, stored in memory, and executed on a processor.

The computer-readable storage media may be provided in a form of non-transitory storage media. Herein, the 'non-transitory storage media' is a tangible device, and may not include a signal (e.g., an electromagnetic wave), but this term does not differentiate between where data is semi-permanently stored in the storage medium and where the data is temporarily stored in the storage medium. For example, the 'non-transitory storage media' may include a buffer in which data is temporarily stored.

The program according to various embodiments of the present disclosure may be included in a computer program product and provided. The computer program product may be traded as a product between a seller and a purchaser.

The computer program product may include a software program and a computer-readable storage medium storing the software program. For example, the computer program product may include a software program product (for example, a downloadable application) electronically distributed through a manufacturing company of an electronic device or an electronic market (for example, Samsung Galaxy Store). For electronic distribution, at least one part of the software program may be stored in the storage media or temporarily created. In this case, the storage media may be a server of a manufacturing company of the electronic device, a server of an electronic market, or a storage medium of a relay server that temporarily stores a software program.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A display device comprising:
a display divided into a plurality of blocks and configured to be driven;
memory storing at least one instruction; and
at least one processor, comprising processing circuitry, individually and/or collectively, configured to execute the at least one instruction stored in the memory,
wherein at least one processor is configured to execute the at least one instruction to cause the display device to:
obtain an input image;
calculate a plurality of duty ratios at which the plurality of blocks are respectively driven within one frame, based on the obtained input image,
calculate a first duty margin using a specified first target duty ratio and a first reference duty ratio selected from among the plurality of calculated duty ratios,
calculate a second duty margin using a second target duty ratio determined by a specified relational expression between a driving current and a driving duty ratio of the display and a second reference duty ratio determined based on the plurality of calculated duty ratios,
determine a correcting duty margin by comparing the first duty margin with the second duty margin, and
drive the display with a plurality of final duty ratios determined using the plurality of duty ratios and the correcting duty margin, and a final driving current determined to correspond to the plurality of final duty ratios using the relational expression.

2. The display device of claim 1, wherein
at least one processor, individually and/or collectively, is configured to execute the at least one instruction to cause the display device to:
select a highest duty ratio among the plurality of calculated duty ratios as the first reference duty ratio.

3. The display device of claim 1, wherein
the first target duty ratio is a ratio set to a highest duty ratio at which the display is capable of being driven within the one frame.

4. The display device of claim 1, wherein
at least one processor, individually and/or collectively, is configured to execute the at least one instruction to cause the display device to:
calculate a difference between the first target duty ratio and the first reference duty ratio as the first duty margin.

5. The display device of claim 1, wherein
at least one processor, individually and/or collectively, is configured to execute the at least one instruction to cause the display device to:
determine an average duty ratio of the plurality of calculated duty ratios as the second reference duty ratio.

6. The display device of claim 1, wherein
the relational expression includes a minimum driving current for driving the display and a minimum driving duty ratio corresponding to the minimum driving current, and
at least one processor, individually and/or collectively, is configured to execute the at least one instruction to cause the display device to:
determine the minimum driving duty ratio as the second target duty ratio.

7. The display device of claim 1, wherein
at least one processor, individually and/or collectively, is configured to execute the at least one instruction to cause the display device to:
calculate a difference between the second target duty ratio and the second reference duty ratio as the second duty margin.

8. The display device of claim 1, wherein
at least one processor, individually and/or collectively, is configured to execute the at least one instruction to cause the display device to:
compare the first duty margin with the second duty margin, determine the first duty margin as the correcting duty margin based on the first duty margin being equal to or less than the second duty margin, and determine the second duty margin as the correcting duty margin according to the second duty margin being less than the first duty margin.

9. The display device of claim 1, wherein
the relational expression includes a first relational expression representing a relationship between the driving duty ratio and the driving current to maintain a constant luminance of the display and a second relational expression representing a relationship between the driving duty ratio and the driving current to maintain constant power consumption of the display, and
at least one processor, individually and/or collectively, is configured to execute the at least one instruction to cause the display device to:
obtain a mode selection input of selecting a first mode in which luminance of the display is maintained constant or a second mode in which power consumption of the display is maintained constant,
based on the obtained mode selection input, calculate the second duty margin using the second target duty ratio determined by the first relational expression and the second reference duty ratio, based on the first mode being selected, and
based on the obtained mode selection input, calculate the second duty margin using the second target duty ratio determined by the second relational expression and the second reference duty ratio, based on the second mode being selected.

10. The display device of claim 1, wherein
at least one processor, individually and/or collectively, is configured to execute the at least one instruction to cause the display device to:
drive the plurality of blocks of the display at the plurality of final duty ratios respectively corresponding to the plurality of blocks and drive the display with the final driving current.

11. A method of operating a display device, comprising:
obtaining an input image;
calculating a plurality of duty ratios at which a plurality of blocks of the display, divided within one frame, are respectively driven, based on the obtained input image;
calculating a first duty margin using a specified first target duty ratio and a first reference duty ratio selected from among the plurality of calculated duty ratios;
calculating a second duty margin using a second target duty ratio determined by a specified relational expression between a driving duty ratio and a driving current of the display and a second reference duty ratio determined based on the plurality of calculated duty ratios;
determining a correcting duty margin by comparing the first duty margin with the second duty margin; and
driving the display with a plurality of final duty ratios determined using the plurality of duty ratios and the correcting duty margin and a final driving current determined to correspond to the plurality of final duty ratios using the relational expression.

12. The method of claim 11, wherein
the calculating of the first duty margin comprises:
selecting a highest duty ratio among the plurality of calculated duty ratios as the first reference duty ratio.

13. The method of claim 11, wherein
the first target duty ratio is a ratio set to a highest duty ratio at which the display is capable of being driven within the one frame.

14. The method of claim 11, wherein
the calculating of the first duty margin comprises:
calculating a difference between the first target duty ratio and the first reference duty ratio as the first duty margin.

15. A non-transitory computer-readable recording medium having recorded thereon a program for performing the method of claim 11, on a computer.
